(19) United States
(12) Patent Application Publication
(10) Pub. No.: US 2011/0004622 A1
(43) Pub. Date: Jan. 6, 2011

(54) Method and apparatus for gathering and organizing information pertaining to an entity

(75) Inventor: Michael J. Marson, Madison Heights, MI (US)

Correspondence Address: RAYMOND R. MOSER JR., ESQ.;MOSER IP LAW GROUP, 1030 BROAD STREET, SUITE 203, SHREWSBURY, NJ, 07702, US

(73) Assignee: BLAZENT, INC.

(21) Appl. No.: 12/288,199

(22) Filed: Oct. 17, 2008

Related U.S. Application Data
(60) Provisional application No. 60/999,275, filed on Oct. 17, 2007.

(51) Int. Cl. G06F 17/30

(52) U.S. Cl. 707/770; 707/791; 707/802; 707/803; 707/705; 707/812

(57) ABSTRACT

A method and apparatus for gathering and organizing data pertaining to an entity by extracting the data from a plurality of data sources associated with one or more tenants, organizing the data into connector files having a predefined structure and associating the data in each connector file with a tenant parameter, and storing the connector files in memory.

### CROSS-REFERENCE TO RELATED APPLICATIONS

This application claims benefit of U.S. provisional patent application Ser. No. 60/999,275, filed Oct. 17, 2007, which is herein incorporated by reference.

### BACKGROUND OF THE INVENTION

1. Field of the Invention

Embodiments of the present invention generally relate to database techniques for gathering and organizing data and, more particularly, to a method and apparatus for gathering and organizing data for one or more entities.

2. Description of the Related Art

Large enterprises purchase substantial amounts of information technology (IT) resources, e.g., computers, printers, scanners, and so on. Systems currently exist for gathering information about the IT resources using manual data entry techniques, where an administrator enters information about their IT resources at the moment of purchase or installation. This information may include serial number, purchase date, software installed and information about the software, and so on. A database of such information is useful in monitoring assets, determining expected life of the resources, tracking software license compliance and such. However, such a manual system is expensive and time consuming to operate. Further, such a system does not include any device that is installed without the administrator's knowledge. In large corporations having many offices, world-wide, the likelihood of the database being incorrect is very high.

Information and insight are at the core of every intelligent business decision. Given the importance of information technology in driving an organization's success, making informed decisions regarding enterprise-wide IT infrastructure and resources is critical. Simply put, an organization must have accurate data regarding the organization's assets in order to make sound business decisions. And not only does the organization need data, but data that clearly supports decision-making that promotes an efficient and cost-effective use of resources.

Typical issues with the information gathered about an organization's IT assets include:
Data may reside in multiple, and possibly incompatible, resources.
Those resources can be dispersed throughout an organization, with little integration between them.
Manual integration of these disparate resources is slow, costly, and often inaccurate or outdated.
Overall, much of the data is incomplete and not up to date.
Reporting on the available asset data often varies in analysis methods, formatting, and availability.

Therefore, there is a need for a method and apparatus for gathering information for one or more entities and organizing the information to be analyzed.

### SUMMARY OF THE INVENTION

A method and apparatus for gathering and organizing data pertaining to an entity by extracting data from a plurality of data sources associated with one or more tenants, organizing the data into connector files having a predefined structure and associating the data in each connector file with a tenant parameter, and storing the connector files in memory.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting a system of one embodiment of the present invention coupled to a plurality of IT data sources organized to form tenants in accordance with another embodiment of the present invention;

FIG. 2 is a flow diagram depicting an overview of a method for gathering and organizing asset information in accordance with one embodiment of the invention;

FIG. 3 depicts a detailed flow diagram of a method of utilizing generic dynamic connectors to gather and organize asset data in accordance with one embodiment of the invention;

FIG. 4 is a functional block diagram depicting a general flow of asset data from source to system to the destination target tables in accordance with one embodiment of the invention;

FIG. 5 is a functional block diagram depicting a specific example of the flow of asset data from source to system to the destination target record;

FIG. 6 depicts a flow diagram of a method of processing asset data in accordance with one embodiment of the invention;

FIG. 7 depicts a conceptual model of the system database instance and the schemas contained within the database;

FIG. 8 depicts one embodiment of a system configuration prior to a schema switch;

FIG. 9 depicts one embodiment of a system configuration after a schema switch;

Table 1 depicts one embodiment of a table populated by UnionTableAction;

Table 2 depicts an exemplary mapping of a union table to a prototype table;

Table 3 depicts a representative sample of an intermediate table that is created by UnionTableAction; and

Table 4 depicts the relationships of various inputs and outputs used for billing categorization.

### DETAILED DESCRIPTION

One embodiment of the invention is a software platform (referred to as the system) that provides a cohesive view of an organizations information technology (IT) assets and the opportunity to identify infrastructure savings. Other embodiments may comprise gathering and organizing information related to real estate (e.g., home and property sales), network transmission equipment inventories, medical or dental records, or any venture where data records are utilized.

Some embodiments of the invention provide several advantages to assist in the successful management of IT assets:
Data integration: Depending on the environmental needs, the system can use data from preexisting sources or gather information on its own. The collected data is then integrated, cleansed, and presented in a variety of ways for reporting purposes.
Data consolidation: By presenting a single, cohesive view of an organization's assets and infrastructure, IT professionals can see and respond to events more rapidly and with a greater degree of success.
Data accuracy: Higher accuracy of asset data concerning utilization, security, hardware/software inventory, and hardware specifications, among other areas of concern.
Data analysis: Standard and customized reporting provides financially-driven analysis, helping align IT with organizational goals.

With near-time access to accurate information about IT resources, embodiments of the invention can show a discrete asset, who is using the asset, what software applications are present on the asset, when the lease for the asset expires, and so on.

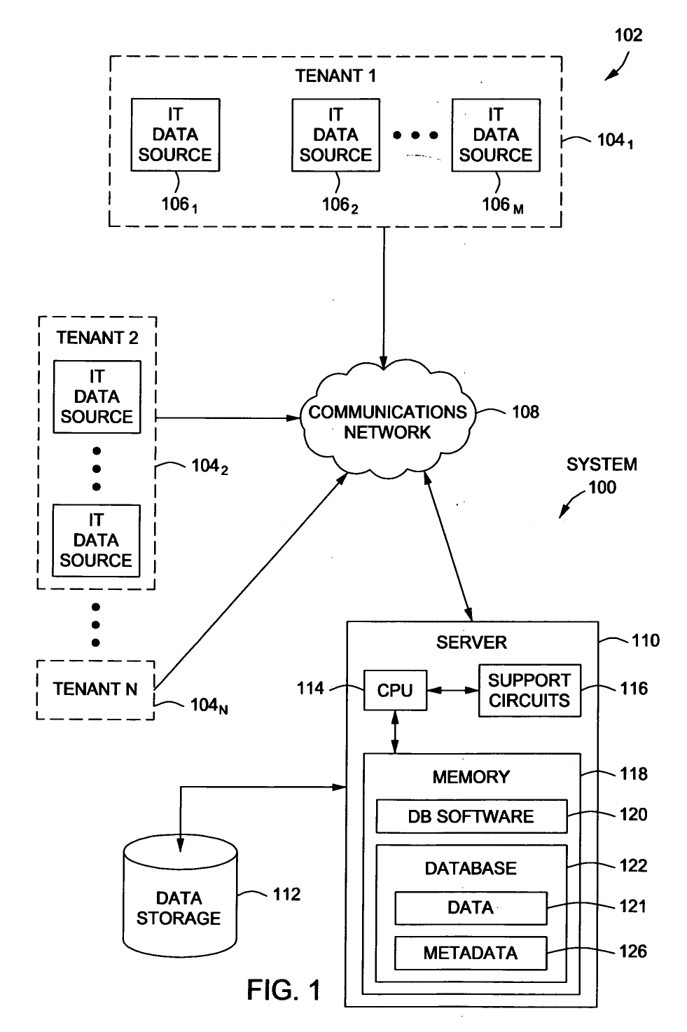

FIG. 1 depicts a hardware block diagram of a system 100 and its data sources 102 (generally not a portion of the system). The data sources 102 belong to various organizations (e.g., companies, divisions of companies, and the like). These organizations are referred to herein as tenants 104₁, 104₂, . . . 104_{N}, where each tenant 104 comprises IT data sources 106₁, 106₂, . . . 106_{M} containing related data sources. Of course, the system may operate in conjunction with a single tenant 104 such that compartmentalizing data by tenant is not necessary. As such, the system can be viewed as capable of operating in two modes: multi-tenant and single tenant.

The data from the data sources 106 is coupled through a communications network 108 to the system (e.g., including a server 110). The system 100 may comprise multiple servers and data storage units; although, only one server 110 and storage 112 is shown. The data storage unit 112 may comprise disk arrays, redundant storage, a storage area network system, or any other type of digital data storage system.

The server comprises at least one central processing unit (CPU) 114, support circuits 116, and memory 118. The CPU 114 may be one or more commercially available processors, microprocessors, application specific integrated circuit, microcontroller, and the like. The support circuits 116 are well known circuits that facilitate functionality of the CPU and comprise clock circuits, I/O circuits, network interface circuits, cache, power supplies, and the like. The memory 118 comprises one or more types of circuit or system for storing digital data and executable programs. Such memory includes, but is not limited to, read only memory, random access memory, disk storage, optical storage, and the like. The memory 118 stores a database 122 and database software 120 (e.g., a structured query language (SQL) database and supporting software). The database 118 stores IT data 121 received from the data sources 102 and metadata 126 used by the database software to perform the functions described below.

In operation, the data 121 from the data sources 102, as described in detail below, is extracted from the sources and organized to create records identifying IT assets of each tenant 104 and various attributes of the IT assets. The database 122 is utilized for storing asset information, manipulating and organizing the information, reporting on the information and so on. The metadata 126, which is either defined or generated by a “configurator” (e.g., a system administrator) facilitates manipulation and organization of the IT data.

More specifically, the database is a relational database containing logical schemas used for different stages of data organization to extract, transform, and load (ETL) processes and data analytics such as:
Metadata that drives integration structure creation, ETL code generation, and application configuration;
A Data Warehouse and Data Mart that holds asset data as well as the consolidated, ‘best of’ asset records, also known as the “Gold Record”; and
Analytic Views that reference data warehouse tables for use in report analytics.

In a Structured Query Language (SQL) environment, the metadata is used as a configuration tool to generate the SQL-based statements and organize the data into tables to facilitate SQL queries. As such, the embodiments of the invention are referred to herein as being metadata-based. The data and meta-data regarding assets are organized as records. The information within records, or the records themselves, can be organized and manipulated as tables.

The system 100 manipulates the information within the database (herein referred to as data integration) to achieve a plurality of goals:
Cleansing of incorrect, out-of-date, redundant, incomplete, or incorrectly-formatted data
Correlation of assets across multiple asset reporting systems
Identifying discrepancies in asset information collected by multiple systems
Consolidation of asset data into a single, trusted record
   In one embodiment of the invention, reporting is based on asset data reported on a per-source basis as well as a cleansed, consolidated, and validated asset record.

The term “gold record” describes a unique asset record that represents ‘best of’ asset data drawn from multiple data sources. To produce a gold record, embodiments of the invention provide a configurable data Integration Framework that allows an organization to manipulate its data in various ways, including:
Cleansing and reconciliation, or how to handle duplicate, null, and mis-matched asset data.
Transformation, the processes by which data values are modified for consistency and proper formatting, or to derive other asset data values.
Consolidation, the means by which data sources and selected columns are combined together to form a picture of an asset. An organization can prioritize the integration of its data on a most-to-least-trusted basis, ensuring that an asset record contains the most complete, valid data that the incoming data can provide.
Standard Content, the incorporation and consideration of standard values represented perhaps through a proprietary or industry standard catalog that can be used to suggest or guide data mappings.

Embodiments of the invention are capable of monitoring and analyzing the IT assets of multiple organizations, or divisions within a single organization. These organizations/divisions are herein referred to as tenants. The system 100 gathers and organizes asset information separately for each tenant as described below.

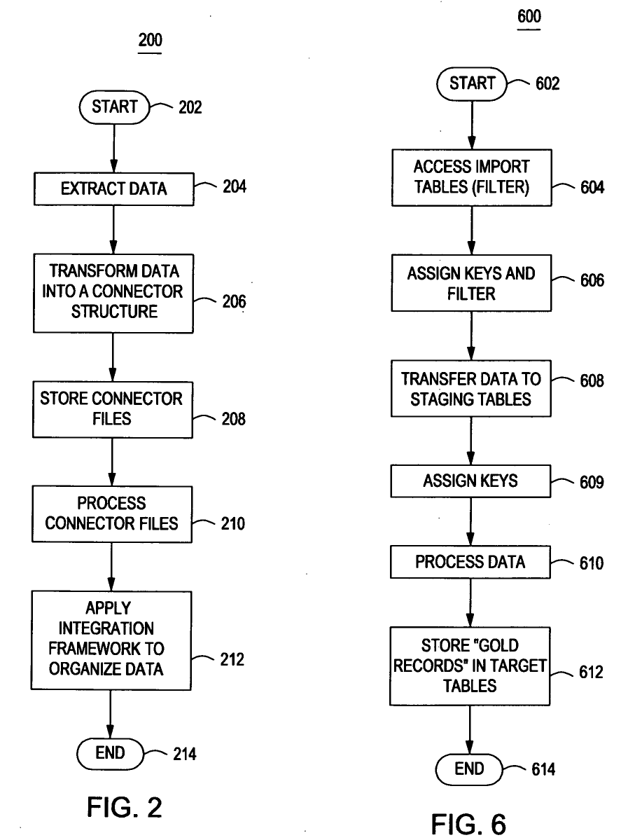

FIG. 2 is a flow diagram depicting a method 200 for extracting data from external sources 102 and organizing the data for storage into a Data Warehouse (storage 112) in accordance with one embodiment of the invention. The method 200 starts at step 202 and proceeds to step 204 wherein asset data is extracted from the external source systems. At step 206, the asset data is transformed into a connector structure (using either the Generic Connector or the Dynamic Connector, as discussed in detail below) and, at step 208, the connector structures are stored as Connector files (CON_*) associated with each tenant. In some embodiments, a Connector file may contain data for multiple tenants where an identification such as a tenant code is utilized to identify the tenant owner of the data. At step 210, the method 200 processes each stored Connector File and loads the corresponding data into Import tables. At step 212, an Integration Framework applies a configurable data source and tenant-specific rules to cleanse, transform, and transfer the data. The method 200 ends at step 214.

More specifically, the system receives data regarding IT assets from a plurality of sources including, but not limited to, asset management systems, human resources system, procurement system, messaging systems, IT asset protection systems (SPAM, virus, and the like), and the like. The data extracted from these sources is then consolidated, reconciled and analyzed in accordance with one embodiment of the invention. The most common external sources include (but are not limited to):
Asset Management
Agent-based discovery
Financial (lease and contract)
Agent-less Network Discovery
Location
Department
User

Each external source typically contains significant overlap in the type of data stored. For instance, hardware inventory detail will often be contained in both Asset Management and Agent-based Discovery systems. One embodiment of the invention identifies disparities in the data details that should be consistent between different data sources. Cost savings and increased revenue result from the comparison of lease/contract and billing systems to that of physical inventory systems exposing overpayment and under-billing opportunities. The logic used to identify such opportunities is configured within the Integration Framework.

The Generic Connector defines a standardized approach to load data from external source systems into the system database. In addition and as a further embodiment of the invention, this standardized approach can be performed in a flexible manner using a Dynamic Connector, as described below.

The Generic Connector consists of a set of data format specifications to which the extracted data sources (Tivoli, SMS, etc.) must conform in order to be processed correctly. Each format specification describes a specific entity/concept, such as Asset, Contract, User, etc. The format specification defines format of a flat file (tables) containing the asset information including placement of data, columns to use, headings to use, and so on.

A combination of scripts, tools, and network structures are used to facilitate the movement and transformation of data from the external source systems into the system; more specifically, a Connector Repository. Data Extraction is the process of reading data from the external source system. The methods used to read the data are largely dependent on the external system's architecture. The extraction process often includes a conversion step to prepare the data for the transformation process.

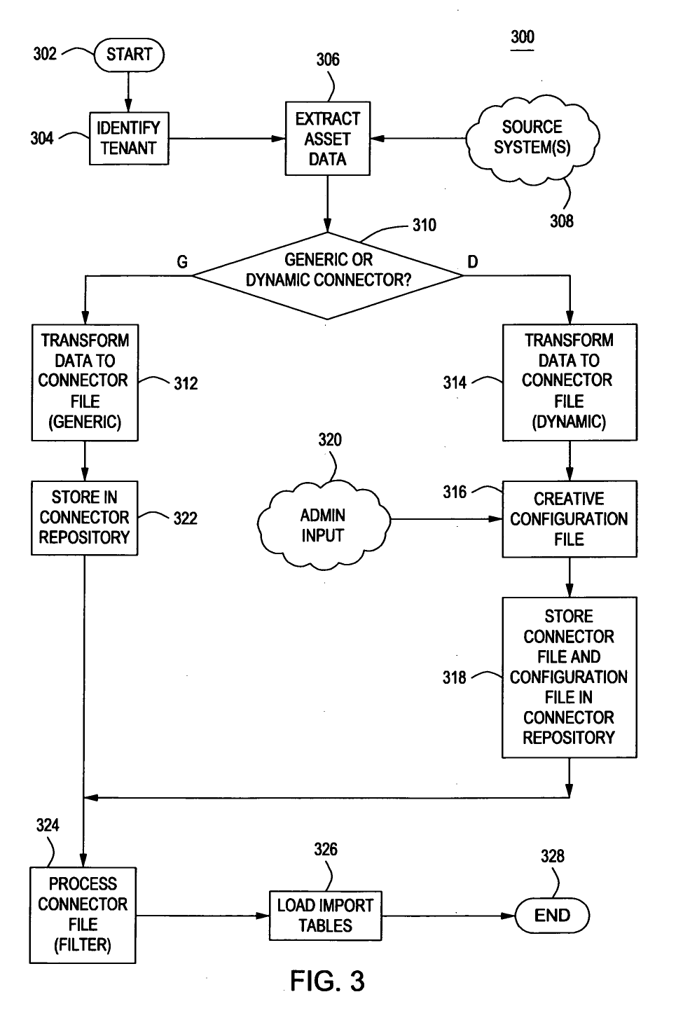

FIG. 3 depicts a flow diagram of a method 300 for generating import tables using generic and dynamic connectors in accordance with embodiments of the present invention. The method 300 begins at step 302 and proceeds to step 304, where a tenant for whom the data will be collected is identified. Specific files to be processed for the identified tenant are discovered by traversing source locations configured in metadata, and filtering files by properties (e.g., name prefix) as configured in metadata. At step 306, the asset data is extracted from the sources (represented at 308).

At step 310, the method 310 queries whether a generic or dynamic connector is to be used. If a generic connector is used, the method 300 proceeds to step 312. Selection of generic or dynamic is typically a predefined configuration parameter related to the absence or presence of a dynamic configuration file.

At step 312, Data Transformation is the process of applying rules and data functions on the extracted data to generate a desired data output format. In this case, the data will be stored as a set of flat files that conform to the Generic Connector format organized by tenant.

At step 322, once the Generic Connector Files have been generated, they are transferred to the Connector Repository which is a central location that collects all tenant data files that are to be loaded used by the system.

The Connector Repository is a storage location where all tenant Generic Connector Files are stored. Once the files have been transferred to this repository they have reached their initial entry point for use by the system. The data stored in the file system-based repository has undergone an initial transformation that conforms to the Generic Connector data model, but primarily contains the original, non-cleansed data, i.e., the data is organized, but not cleansed.

In one embodiment of the invention, the repository is implemented as an FTP server whereby the Generic Connector Files are sent to a shared directory from each of the external sources via an FTP transport mechanism, such as a secure FTP transport mechanism. A script is typically used to copy the Generic Connector Files from the initial directory to an import/staging directory for processing by an Integration Framework. This decoupling allows for file updates to be sent at anytime of the day without impacting any processing being performed by the system. The repository is configured to:
receive and store inbound data files from external sources
allow scripts to be scheduled for execution
allow data files to be retrieved by a database server

To define a generic connector file, the Generic Connector defines a set of data structures that represent the asset-related entity types that can be imported into the system. The Generic Connector approach is entity-centric rather than source system or system type-centric. That is, there is a single asset connector format, to which all systems that contain assets (Asset Management, Agent Discovery, and the like) shall conform. The primary entity types include but are not limited to:
Assets
Users
Departments
Locations
Contracts
Licenses
Procurements
   The data from each external source system is extracted data into one or more Generic Connector Files by tenant and/or tenant group.

Every Generic Connector table has the following keys:
TENANT_CODE—unique tenant identifier string which represents the highest hierarchal level of grouping within a multi-tenant system.
DATA_PARTITION_CODE—unique identifier string; one level below the TENANT hierarchy. This is used primarily for large TENANTs requiring data restrictions at a more granular level (e.g. divisional level).
SOURCE_CODE—unique data source identifier string (i.e. “TIVOLI”)
NATIVE_<entity>_ID—native unique identifier for the <entity> (asset, etc.) from the source system (i.e. COMPUTER_SYS_ID from Tivoli)
   TENANT_CODE, DATA_PARTITION_CODE, and SOURCE_CODE are also required fields for every Generic Connector file. Each Generic Connector File structure will also define one or more additional required fields to ensure that each data record is unique across all tenants. Such keys are added during data transform at step 312.

The following list defines the characteristics of one embodiment of the Generic Connector file format:
Stored as a plain text file (i.e. flat file).
ASCII encoded.
The flat file column delimiter is the vertical bar or “pipe” character (“I”), ASCII 124.
Character string data is optionally enclosed in quotes. That is, both quote-enclosed and non-quote-enclosed character string columns are supported.
All columns in the Generic Connector specification are included in the extracted file. Optional columns, which are null or not present in the external system, are present (as successive delimiters) in the extracted file.
The newline character is used to signify the end of a record.
May contain one or more header rows for comments and/or column header naming.
For uniform identification, all Generic Connector structures begin with identification of tenant, sub-tenant and source. All TENANT_CODE, DATA_PARTITION_CODE and SOURCE_CODE values shall be all upper case with no spaces. Tenant code shall be unique for each tenant and consistent for the tenant. SOURCE_CODE shall be unique for each source type (SMS, TIVOLI, etc.) and consistent for the source instances across all tenants.

The system supports the configuration of multiple directories in which the Generic Connector Files extracts are stored. The system supports multiple Generic Connector Files of the same type, either in the same directory or in multiple directories. All directories are directly accessible by the database server process.

The directories are partitioned to reduce the possibility of file name clashing and to allow for more finely grained access control. The directory names are not interpreted as indicative of the tenant name or source type.

The filename has an indicative prefix, corresponding to the type of data it contains, i.e. CON_ASSET, CON_USER, etc. Further, name clashing must be avoided where multiple sources and/or tenants are providing extracts of the same entity type. For that, there are several conventions that should be employed and strictly enforced by agreement, though none are mandatory since the best strategy is dependent on the particulars of a specific implementation. Possible examples include:

<entity>-<tenant_code>
<entity>-<tenant_code>_<subtenant_code>
<entity>-<tenant_code>_<subtenant_code>_<source_code>

The management of extracted Generic Connector Files (adding, updating, deleting, replacing) is outside of the scope of this document and the system.

The number of files of a specific type not need be configured or known in advance. The system recognizes, imports and processes all files in the configured directories matching the indicative prefixes. The union of all files shall be considered to be the definition of “current state” with respect to the external systems.

Use of a single global date format for all generic connector file extracts is recommended. A parameter is supported in metadata to allow for the configuration of this global data format mask, such as “YYYY-MM-DD HH24:MI:SS”. Additionally, generic connector structures that contain date fields contain a DATE_FORMAT column that allows for the specification of a data format mask that applies only to the single row. In this way, non-default data formats can still be supported, albeit with the requirement of additional work during extraction. In the case where the default date format is to be used, the DATE_FORMAT can be left null.

At step 324, the connector files are accessed within the repository and processed (filtered) as they are loaded, at step 326, into import tables. At step 324, the extracted data within the connector repository is stored in import tables, the structure of which mirrors the structure of the original data source. There may be a small amount of transformation performed in this process, but the use of staging tables (see FIGS. 3-5) allows for subsequent SQL and procedural logic to be applied uniformly to all sources of data. At this step, in one embodiment, filtering is performed such that a subset of data can be “ignored” prior to importation, i.e., records that satisfy the filter condition are imported and records that do not satisfy the filter condition are excluded from importation. The method 300 ends at step 328.

If the method 300 selects a dynamic connector at step 312, the method 300 proceeds from step 310 to step 314. Given the file and structure requirements for the Generic Connector, allowing for flexibility in defining Generic Connector structure formats eases the burden on administrators performing data extractions. In addition, some organizations may not have data for all the Connector columns, also necessitating the ability to configure a more flexible extract format.

At step 314, the data is transformed into a connector file. The Dynamic Connector is a mechanism that allows definition of more than one format for the CON_* tables and deal with data issues. In one embodiment, the Dynamic connector uses a separate XML configuration file paired with the data extract file. The configuration file is generated at step 316 using input from an administrator 320. This configuration file directs the Integration Framework to allow for a customized interpretation of the associated CON_* data file's content; however, there are requirements that must be met to allow for the use of custom data extracts that do not fit the Generic Connector model.

For each con file (CON_*) data extract that is governed by a dynamic connector configuration file, there is a matching configuration xml file that, in one embodiment, is defined as follows:
The configuration file exists in the same directory as the con file.
The configuration file is an XML file with an “.xml” suffix.
The configuration file name has a prefix that matches the prefix name in IF_SOURCE_LOCATION_STRUCT.CONFIG_STRUCTURE_PREFIX.
   Example: A typical naming convention used specifies the dynamic connector file prefix of “CFG-CON_*” where the data extract file is named “CON_*”.
The remainder of the configuration file name, excluding the .xml suffix, is matched to the connector data file name, excluding its suffix.
   Example: A configuration file for CON_ASSET.csv would be named CFG-CON_ASSET.xml.
      Note: Data extract files that conform to the primary (default) Generic Connector format do not need a configuration file. If a configuration file is absent, the ETL processes assume that the extracted data file conforms to default file formats and structures.

The connector file and its related configuration file are stored at step 318 in the connector repository.

There are two major sections to the configuration file: (1) file level parameters and (2) column level parameters.

The supported file-level parameters are:
headerRowCount: Number of records to skip at beginning of file. This overrides the globally-set parameter
dateFormatMask: File-level date format mask to use for all date fields in this file. This overrides the globally-set parameter, and is itself overridden by the record-level value
fieldDelimiter: The value used to delimit individual fields, typically ASCII 124 (pipe symbol)
recordDelimiter: The value used to delimit records. Typically NEWLINE named delimiter (i.e. carriage return/new line)
   All of the above parameters are individually optional. The parameter of headerRowCount can be specified without setting a dateFormatMask parameter. The absence of a parameter is read by the dynamic configuration to mean that global and/or record parameters are used as default parameters. All defaults are driven by metadata configured in the Integration Framework.
   The supported column-level parameters are:
column: The target column name. The order and presence of column elements in the XML file directly drives the interpretation and mapping of columns during the insert from the external table to the import table. This column element can have optional type and value attributes:
   standard: This is default, normal column that exists in external file and will be imported. If no type attribute is specified, the column is interpreted as a standard column.
   virtual: This indicates a column that does not exist in external file but will be virtualized in a wrapping view and treated as a column on import. The value attribute determines the column's literal value. An optional dataType attribute can be specified with the virtual type.
   split: A column (whose name is specified by value parameter) that exists in external file as a different column being imported. Splitting this column will ‘split’ the named column's values into a different column in the wrapping view.
   ignore: This indicates a column that exists in external file and which should not be imported. This must still be defined in external file so column offsets are correct.
   override: Indicates a column that does exist in external file but will be overridden as a virtualized column in the wrapping view and treated as a column on import. The value parameter determines the value, and an optional dataType attribute can be specified with the override type.
   externalName: This column attribute allows documenting of a column mapping by capturing the original name of the external column from the external source.
      Note: If any columns in the XML file are specified, the column order is specified exactly and completely in the XML file. This is necessary to maintain proper column sequencing; missing column offsets will cause data import errors.

The optional dataType column attribute (only used with the virtual and override types) determines whether or not the virtual value is wrapped in single quotes. Here are the supported dataTypes:
numeric: The virtual column will not be wrapped in single quotes
char: The virtual column will be wrapped in single quotes
noquote: The virtual column that will not be wrapped in single quotes. This is a catch-all for non-char types.
   There are variations to configuring the dynamic connector file. The data can:
Specify column orders but not file parameters (in which case the default file parameters are used),
Specify file parameters but not columns (in which case the default columns are used.)

Given the connector file extract name is “CON_ASSET.csv”:
The prefix configured in the IF_SOURCE_LOCATION_STRUCT table's CONFIG_STRUCTURE_PREFIX column for that extract is “CFG-”.
The name of the dynamic connector configuration file is named “CFG-CON_ASSET.xml”.
The dynamic connector configuration file “CFG-CON_ASSET.xml” is placed in the same directory as “CON_ASSET.csv”.

The data extract file, CON_ASSET.csv, contains the four required fields (TENANT_CODE, DATA_PARTITION_CODE, SOURCE_CODE, NATIVE_ASSET_ID) plus a simple data format of ASSET_NAME and ASSET_TAG.

The CFG-CON_ASSET.xml file that modifies the connection from the system to the customized six-column CON_ASSET.csv file would resemble the following:

```
<?xml version=“1.0” encoding=“utf-8” ?>
<blz:connectorConfig xmlns:blz=
“http://www.blazent.com/xmlbeans/connectorconfig”>
<columns>
    <column name=“TENANT_CODE” />
    <column name=“DATA_PARTITION_CODE” />
    <column name=“SOURCE_CODE” />
    <column name=“NATIVE_ASSET_ID” />
    <column name=“ASSET_NAME” />
    <column name=“ASSET_TAG” />
</columns>
</blz:connectorConfig>
```

IN one embodiment of the invention, file-level parameters are specified using the <fileParameters> tag as shown here:

```
<?xml version=“1.0” encoding=“utf-8” ?>
<blz:connectorConfig xmlns:blz=
“http://www.blazent.com/xmlbeans/connectorconfig”>
<fileParameters>
    <parameter name=“headerRowCount” value=“1” />
    <parameter name=“dateFormatMask”
    value=“YYYY/MM/DD HH24:MI” />
    <parameter name=“fieldDelimiter”
    type=“ascii” value=“124” />
    <parameter name=“recordDelimiter” type=“namedDelimiter”
    value=“NEWLINE” />
</fileParameters>
<columns>
    <column name=“TENANT_CODE” />
    <column name=“DATA_PARTITION_CODE” />
    <column name=“SOURCE_CODE” />
    <column name=“NATIVE_ASSET_ID” />
    <column name=“ASSET_NAME” />
    <column name=“ASSET_TAG” />
</columns>
</blz:connectorConfig>
```

To only override the dateFormatMask parameter, only that parameter in the <fileParameters> tag need be specified:

```
<fileParameters>
    <parameter name=“dateFormatMask”
    value=“YYYY/MM/DD HH24:MI” />
</fileParameters>
```

If the CON_ASSET.csv file extract has ASSET_TAG first then ASSET_NAME, just change the ordering of the XML <column> elements:

```
<columns>
    <column name=“TENANT_CODE” />
    <column name=“DATA_PARTITION_CODE” />
    <column name=“SOURCE_CODE” />
    <column name=“NATIVE_ASSET_ID” />
    <column name=“ASSET_TAG” />
    <column name=“ASSET_NAME” />
</columns>
```

The following are column element configuration examples (virtual, split, ignore, override)

virtual type:

A data extract is provided containing a single data partition for a single tenant, but lacks the required TENANT_CODE or DATA_PARTITION_CODE columns, necessitating the creation of those columns. In this case, the TENANT_CODE column a value of “TENANT1” and the DATA_PARTITION_CODE column a value of “PARTITION1” is also supplied.

```
<columns>
    <column name=“TENANT_CODE”
        type=“virtual”
        value=“TENANT1” />
    <column name=“DATA_PARTITION_CODE”
        type=“virtual”
        value=“PARTITION1” />
    <column name=“SOURCE_CODE” />
    ...
```

split type:

A CON_ASSET data extract does not have a NATIVE_ASSET_ID populated, but does have a unique ASSET_TAG column. However, this column is already being mapped to ASSET_TAG in import. This would require the creation of a split column for ASSET_TAG going to NATIVE_ASSET_ID, while retaining the existing mapping for the ASSET_TAG column.

```
<columns>
    ...
    <column name=“NATIVE_ASSET_ID”
        type=“split”
        value=“ASSET_TAG” />
    <column name=“ASSET_TAG” />
    ...
```

ignore type:

A CON_ASSET data extract has extra “junk” columns that do not require importing, necessitating the designation of ignore columns for any columns to be suppressed. These columns are still created at the external table level (since the column offsets must be accounted for), but they are not created in the wrapper view, and are not participants in import.

Note: The “IGNORE” mapping type in IF_TABLE_COLUMN_MAP can be used, but this would still require a record in IF_TABLE_COLUMN_MAP. In addition, if there are other extracts that are attempting to use the Generic Connector (no Dynamic Connector), those extracts would have to include the junk columns in order to line up the column offsets correctly. Using the ignore type eliminates the need for a record of these columns in metadata.

```
<columns>
    ...
    <column name=“JUNK_COLUMN_1”
        type=“ignore” />
    <column name=“ASSET_TAG” />
    <column name=“JUNK_COLUMN_2”
        type=“ignore” />
    ...
```

Ignore columns do need to have unique names within the columns in the file. Ignore columns that do not match a record in IF_TABLE_COLUMN_MAP are created with the default parameters of VARCHAR(255) in the external table.

override type:

An extract has a column that is empty or only partially populated and the value in the column should or could be uniform for the whole file. An example could be a metadata column like LOCATION_DATA_SOURCE_TYPE or a column like TOTAL_DISK_UNITS. This would require the creation of override columns, which override the value in an existing external column with a specific value. Note that functionally this is essentially the same as an ignore column-virtual column pair, but can be done with a single type:

```
<columns>
    ...
    <column name=“TOTAL_DISK” />
    <column name=“TOTAL_DISK_UNITS”
        type=“override”
        value=“GB” />
    ...
```

externalName attribute:

Documenting the column mapping inside the XML is a good practice and a way to make sure that the mappings are understood, maintainable and kept up-to-date. It may be most useful where the name of the GC column and the external column name are significantly different.

```
<columns>
    ...
    <column name=“NATIVE_ASSET_ID”
        externalName=“RESOURCEID” />
    ...
```

dataType attribute for virtual and override column types:

In a virtual or override column the target column is a numeric type, not a char type. This might require a data type conversion such as forcing all TOTAL_DISK values in an extract to be “0” in an extract that is missing the column.

```
<columns>
    ...
    <column name=“TOTAL_DISK”
        type=“virtual” value=“0”
        dataType=“numeric” />
    <column name=“TOTAL_DISK_UNITS”
        type=“virtual”
        value=“GB” />
    ...
```

At step 324, the movement and organization of data within the system schemas to import tables is managed by the system's Integration Framework. The Integration Framework allows for the configuration and performance of various ETL and database functions.

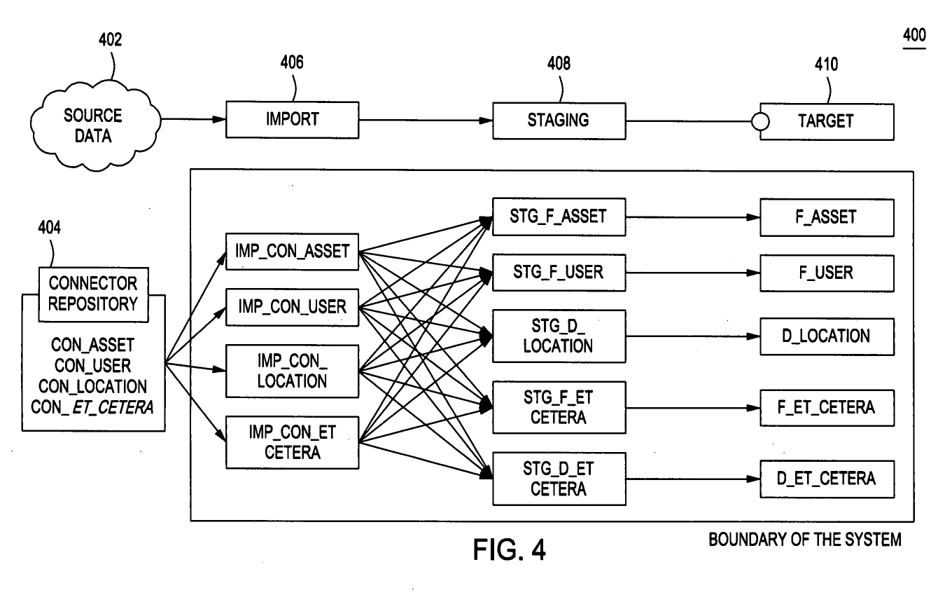

FIGS. 3 and 4 depict functional block diagrams of the flow of asset data from data sources to the destination target tables.

Note: Table names and naming conventions shown here will vary between different system implementations.

In FIG. 4, as described above, source data 402 is stored in a connector repository 404 as raw asset information organized for use by the system. The extracted data enters the system as discussed above using the Generic/Dynamic Connector and is stored in import tables (IMP_*) 406, the structure of which mirrors the structure of the original data source.

The data is then transferred into the various asset staging tables (STG_*) 408. At this point, no processing of data has been performed amongst data from the sources; for a single, unique asset or user that is present in one or more source systems there will be one or more records in the staging tables 408.

The asset records reaching target tables 410 are considered to be the “Gold” (the processed asset information using the ‘best of’ data from multiple data sources) records, although performing further data scrubbing on the processed data in the target tables 410 is a typical action performed. At this point, the asset data integration is considered to be complete from the perspective of mapping and transfer functions.

Note: For asset data that does not map to the system schema, extended tables can be created to contain information not accounted for in the system structure. Table extension and view extension are handled as part of the Integration Framework. Both the analytics views and reports will have to be modified to take advantage of any custom fields in any extended assets tables.

Within the integration process, tasks—also referred to here as processes—are configured in the Integration Framework to perform specific manipulations of the warehouse tables and the data contained therein.

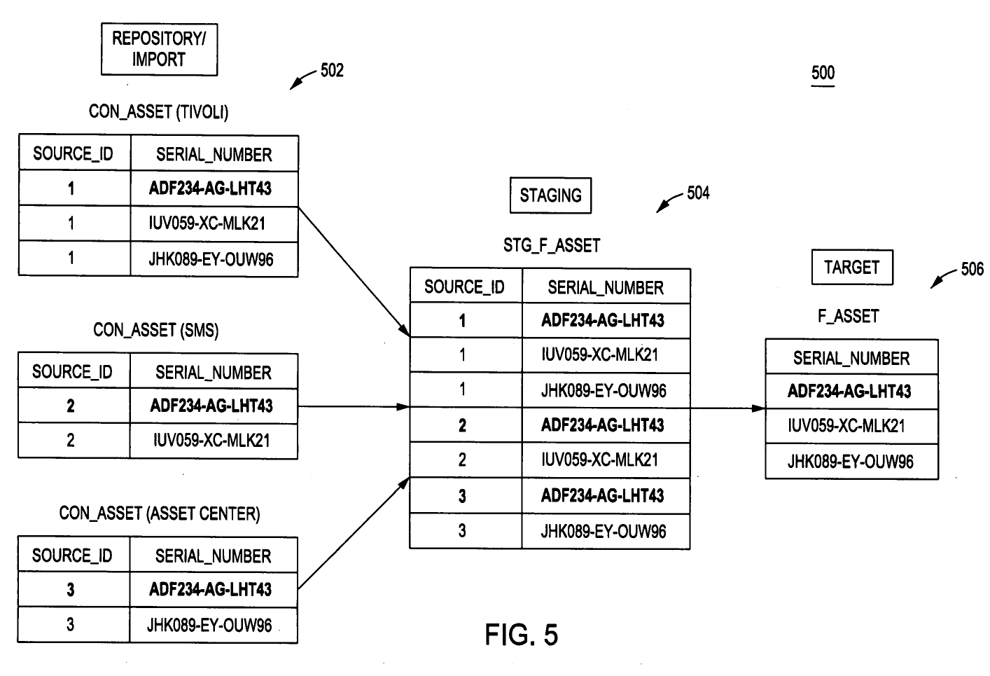

FIG. 5 depicts an example of the process used to attain a target table. At 502, the raw data from various sources is organized in the import tables by source_ID (an identifier of the data source). For each source, a number of assets are identified by serial number. At 504, the data is organized (consolidation may occur to remove duplicate assets). The data from 504 is processed to produce a target table 506.

FIG. 6 depicts a flow diagram of a method 600 for processing asset data in accordance with one embodiment of the invention. The method 600 starts at step 602 and proceeds to step 604 where the method 600 accesses the import tables.

In one embodiment, at step 606 the processes performed on the target tables include at least one of:
Basic entity key assignment, which is assigning ID values to records from specified sequences
Key merging is the process by which ID values are assigned to unique combinations of columns. This would be used, for example, when re-normalizing software items and software entries from a flat item-entry structure.
Preliminary cleansing, such as normalization of common data between multiple systems.

At step 608, the method 600 maps the fields from the various import tables and transfers the mapped data into the various asset staging tables. As mentioned earlier, at this point in staging, an asset that is present in one or more source systems will have one or more records in the staging tables. At the end of this process, the data has been placed into the various data warehouse target table structures.

At step 608, additional key assignment and association of asset records is occurs. Unique assets identified by common fields are assigned key values and customer-specific logic is applied to the staging tables. At the end of this section of the process, the one or more asset records from one or more sources will be linked by common, system-generated asset IDs.

At step 610, data processing is performed to create a final consolidation of records into the single, reconciled asset record, referred to as the Gold record. Each field in the final reconciled asset record will be fed using a source-prioritization structure that can be configured to vary on a column-by-column basis. At step 612, the Gold asset records are transferred to the target tables.

At step 612, the method 600 allows for setting of column values that are not part of the imported data. Examples include setting statuses and default values. The method 600 ends at step 614.

The data within the target tables, staging tables, and extension tables can be used in reports. Of particular interest are the staging tables, which contain data source identifiers for each tenant, allowing the system to accommodate analytics focused on data reconciliation and conflict issues.

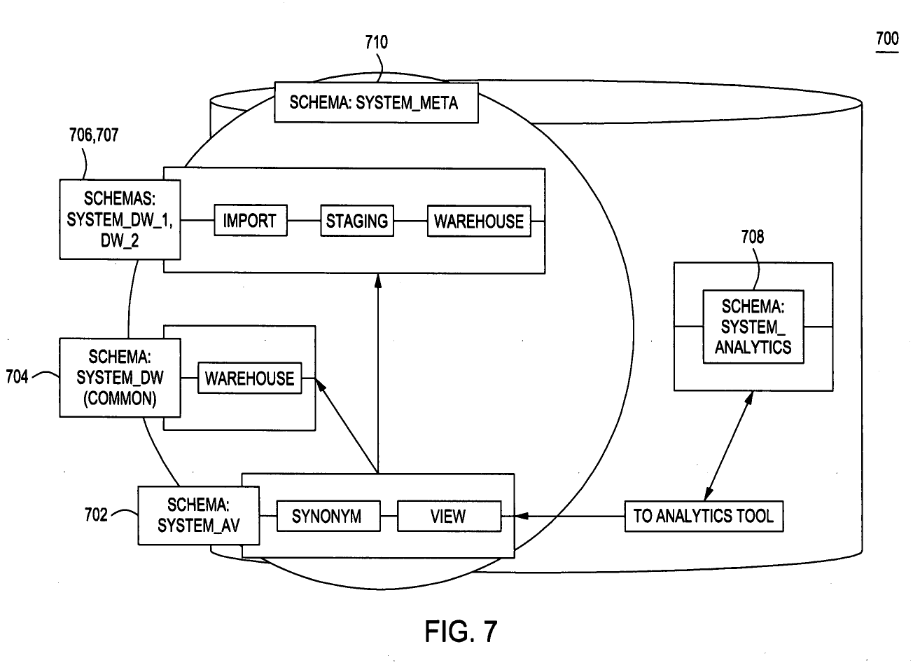

FIG. 7 depicts a conceptual model 700 of a system database instance and schemas contained within the database. The arrows indicate the data flow within the system database instance; the views in the SYSTEM_AV schema 702 reference tables and columns in the SYSTEM_DW schema 704 and the SYSTEM_DW 1 or 2 schemas 706, 707, while the system stores and accesses its report objects in the SYSTEM_ANALYTICS schema 708.

The SYSTEM_META schema 710 is the main controller of the system platform. The tables contained in the SYSTEM_META hold data related to various components of the system platform. The tables pertinent to a discussion of the system Integration Framework include the following:
BZ_VLD_x: Constraint definitions, exceptions, and deletions
BZM_SCHEMA_MAP: Schema definitions and their roles
IF_x: Integration Framework metadata tables containing data that guide integration of asset data. These tables are prefixed with the characters ‘IF_’.
Qx: Tables (prefixed with ‘Q’) holding information about data quality metrics performed within the system

The structures of the DW_1 and DW_2 schemas 706, 707 are duplicates of each other. This is due to their function in the system platform as twin repositories for asset fact data, or asset data that is specific to an individual asset (such as serial numbers, or machine names) and technically should not be found in other asset records. The tables contained in the SYSTEM_DW_1 and DW_2 schemas 706, 707 hold asset data as it moves through the processes of data gathering and organization, as described above.
Error tables (if specified to exist) are used to hold records that, when brought into the system, trigger configured error checks.
Fact tables (having a ‘F_’ prefix) are used to store asset data that is specific to a unique device, user, or contract.
Import tables (having an ‘IMP_’ prefix) contain data brought into the system from an outside location, including the system Generic Connector's repository. This data closely resembles what is present in the source data and retains much of that source's native structure. Import tables are specified in the system Integration Framework.
Data Quality tables (prefixed with a ‘Q’ contain quality characteristics of assets and the data that comprises those assets.
Staging tables (having a ‘STG_’ prefix) contain data which is transferred from the Import tables into Staging columns mapped to the target Fact tables and data warehouse. Staging tables are specified in the system Integration Framework.

The function of the SYSTEM_DW 704 is to store dimensional data, or data about an asset that is not unique in nature, such as a machine model or the state/province location of an asset's user. Most of the DW Common tables are prefixed with a ‘D_’ or ‘DW_’. The only exceptions are tables related to remarks and status on various asset management areas.

The SYSTEM_AV schema 702 is a container for various Analytic Views and database synonyms. The creation of this schema was necessary to shield the reporting engine from the schema switch mechanism.

Two goals of this database schema switch mechanism are:
Minimum interference with the reporting engine during ETL runtime as the loading schemas are not used in reporting
Minimum downtime during ETL runtime; the switch process only takes a few seconds

The issue is handled with the creation of two mirrored data warehouses, specifically the SYSTEM_DW_1 and _2 schemas 706, 707 described above. Simply put, one schema is used for reporting purposes and the other is loaded with fresh data by the ETL process. As soon as the ETL process is finished, the pairs are switched. Then, the loading schemas become the reporting schemas, and vice versa. Views and synonyms contained in the SYSTEM_AV schema are used to implement the switching mechanism.

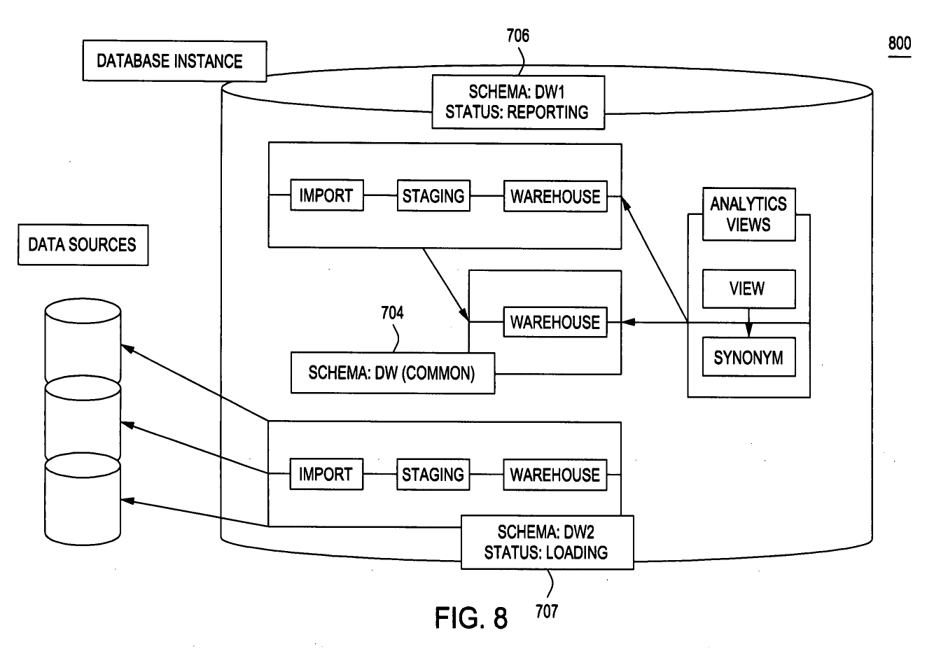

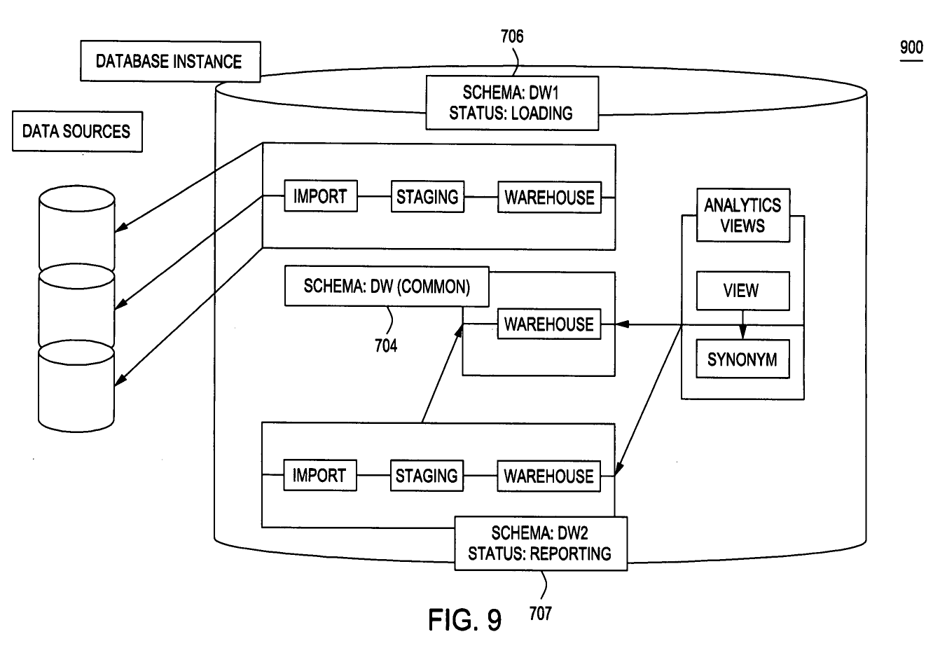

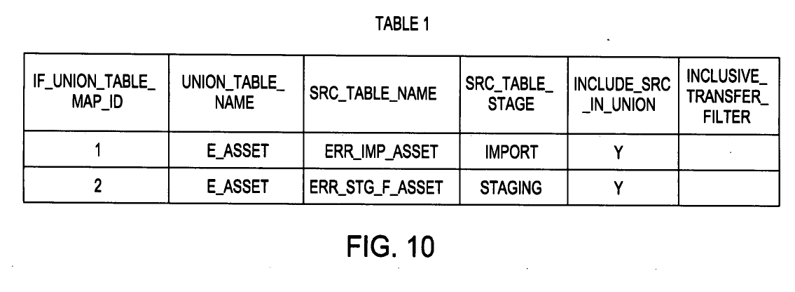

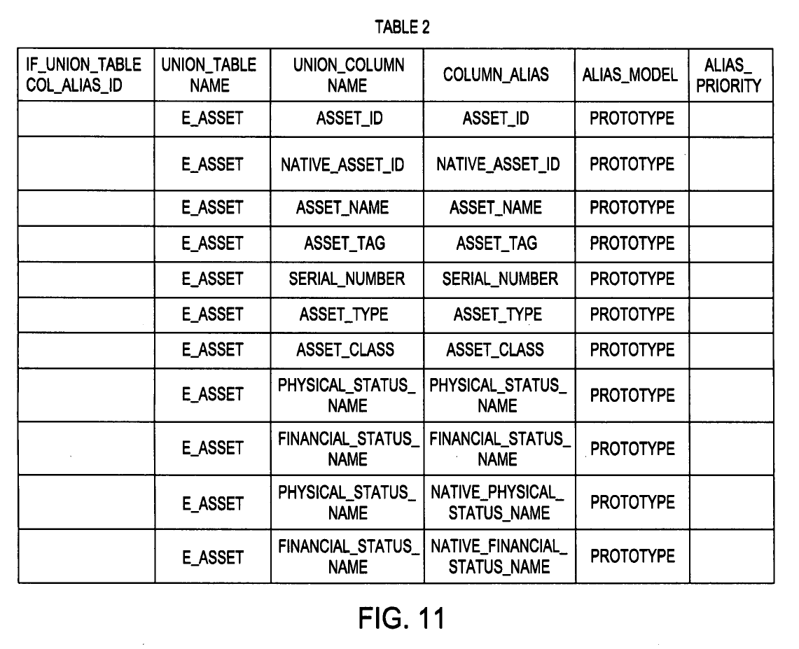

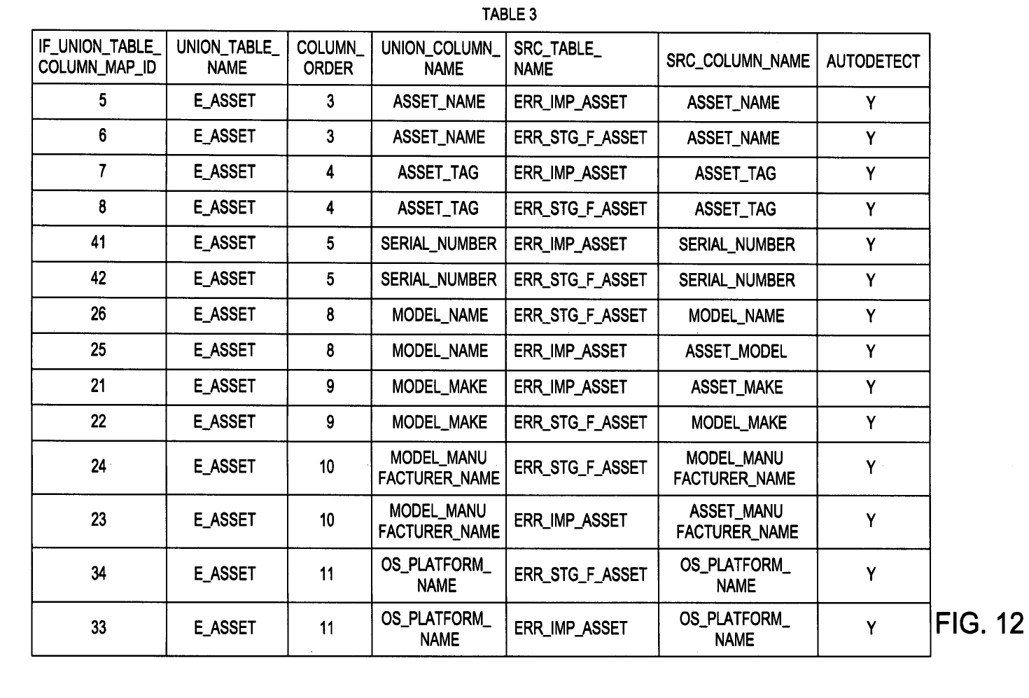

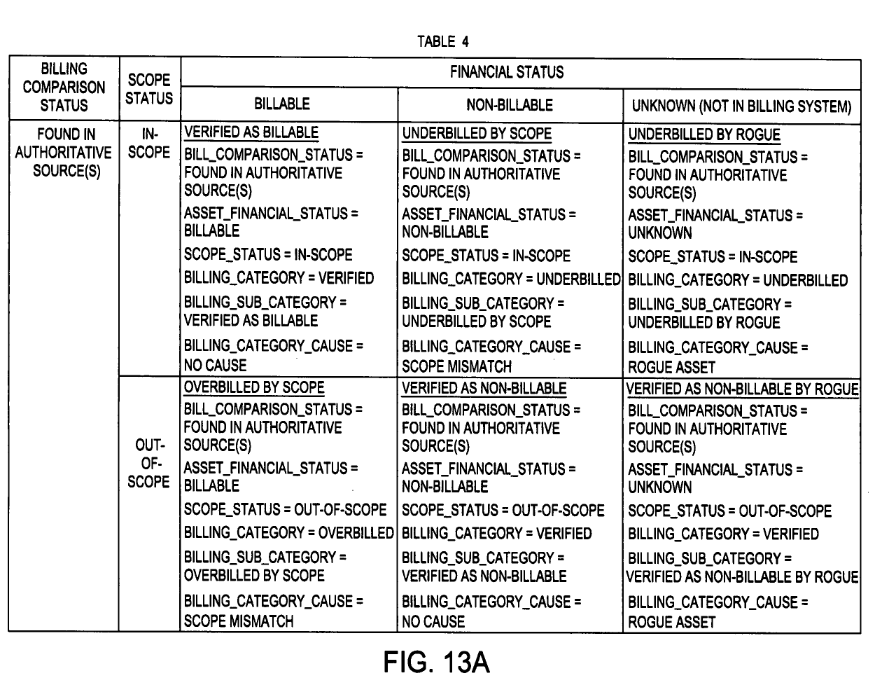

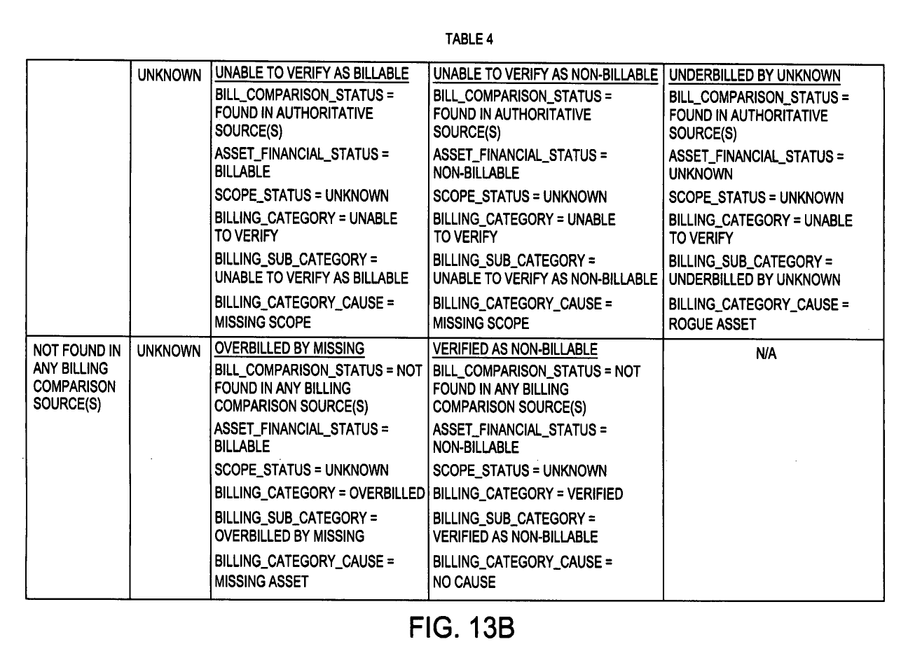

FIG. 8 depicts the system configuration 800 before the switch. During the switch process the synonyms are dropped and recreated to point to the other database. FIG. 9 depicts the system configuration 900 after the switch. Within SYSTEM_AV, the common warehouse synonyms always point to the loading schema, while the analytical views synonyms always point to the reporting schema.

In the system, certain tasks are necessary to perform in order to successfully integrate asset data from multiple sources. Such processes in the system Integration Framework and related Integration Framework tables include:
Source definition
Creation and deletion
Data mapping and transfer
Data transformation
Error and conflict
   DQT
   Validation
Association
Consolidation
Key assignment
Key merge
Tenant configuration
Data structure configuration and definition
Rulesets
Miscellaneous Integration Framework functions
Reporting

In addition, many of the process areas listed above must be configured to occur in a specific order during the system integration synchronization. This is also handled by the Integration Framework, as well as a few other miscellaneous tasks.

In the area of source definition, tables define data sources to the Integration Framework. Supporting metadata tables include the following:

### Metadata Tables for Source Definition

| Table Name | Description |
|---|---|
| IF_SOURCE | This table contains the master list of data |
| | sources, along with standard naming |
| | conventions and link ID column creation |
| | detail. |
| IF_SOURCE_ENTITY_TYPE | Join table matching a source to a data |
| | entity listed in the IF_ENTITY_TYPE table. |
| IF_SOURCE_LOCATION_STRUCT | Defines the characteristics of a data source |
| IF_SOURCE_MATCH_CFG | |
| IF_SOURCE_LOCATION | Defines the location of the data source. |

Creation and deletion processes create the data structures used by the remainder of the reconciliation processes; import and staging tables, columns that extend the data model, and custom data entities. Provided functions include:
Create import tables
Create staging tables
Create base extension tables
Create new data entity tables
Addition of new columns to standard base tables
Drop tables
Delete/truncate data

Supporting metadata tables include the following:

### Metadata Tables for Creation and Deletion

| Table Name | Description |
|---|---|
| IF_TABLE_CREATION | This table contains detail on tables to be |
| | created; tables can be newly created |
| | structures or structural copies and |
| | augmentations of existing tables. |
| IF_TABLE_DELETION | Identifies tables to be either truncated or to |
| | undergo a conditional delete of its contents |
| IF_SOURCE | Concerning Creation processes, the |
| | IF_SOURCE table identifies source link ID |
| | columns and sequences to be created. |
| IF_TABLE_COLUMN_MAP | Specifies the columns and column |
| | characteristics to be created in warehouse |
| | tables. |
| IF_TABLE_INDEX | Specifies the table a custom index is to be |
| | created for |
| IF_TABLE_INDEX_COLUMN | Specifies the column(s) the index will be |
| | based on |
| IF_SEQ_CREATION | Allows the creation of custom sequences |
| IF_UNION_TABLE | Identifies the characteristics of a table used |
| | to combine the result of two SELECT |
| | statements |
| IF_UNION_TABLE_COLUMN_MAP | Specifies how a source table and column |
| | relates to a union table and column |
| IF_UNION_TABLE_COL_ALIAS | Allows the configuration of column aliases for |
| | a union table |
| IF_UNION_TABLE_MAP | Allows configuration of the characteristics of |
| | the UNION statement |
| IF_VIEW_DEF | Specifies the view to be created |
| IF_VIEW_DEF_TABLE | Specifies the tables to be included within the |
| | view |
| IF_VIEW_DEF_TABLE_COL | Identifies the table-specific columns to be |
| | included in the view. |
| IF_CUSTOM_INDEX | Defines a custom index to be created and its |
| | characteristics |
| IF_CUSTOM_INDEX_COLUMN | Defines a single column to be created in a |
| | custom index |
| IF_TABLE_CONFIG | Contains table configuration information for |
| | data model extensions. |

Data mapping and transfer processes perform the heavy lifting of the overall reconciliation process, by transferring data through external and import tables, through staging tables, to the target base and extension tables. Provided functions include:
Transfer data from external data sources to import tables
Transfer data from import tables to staging tables Perform data type transformation when required (varchar-to-number, number-to-varchar, et cetera)
Varchar length truncation when needed by column mismatch (i.e. target is narrower than source)
Copy column from single source to multiple destinations

Supporting metadata tables include the following:

### Metadata Tables for Data Mapping and Transfer

| Table Name | Description |
|---|---|
| IF_CORE_TABLE_COLUMN_MAP | Defines a mapping to be used to transfer a |
| | column's data to various stages in the |
| | integration process |
| IF_TABLE_CONFIG | This table contains additional per-table |
| | configuration values that are applicable to |
| | the data mapping process. |
| IF_COLUMN_MAPPING_TYPE | Lists data column mapping types by ID and |
| | describes the associated mapping function |
| IF_STAGE_TYPE | Lists the various stages that asset data flows |
| | through during an integration sync |
| IF_TABLE_COLUMN_MAP | Describes how data is mapped from import |
| | to staging to data warehouse standard and |
| | custom entities. Also defines the columns to be |
| | created in the target tables. |

Data transformation processes perform some form of data transformation. Motivations for data transformation include data normalization and conversion. Data transformation can be applied at multiple stages of the standard process. Provided functions include:
Performance of data transformations on specified columns at specified stages in the standard process.

Supporting metadata tables include the following:

### Metadata Tables for Data Transformation

| Table Name | Description |
|---|---|
| IF_DATA_TRANSFORM | Identifies a specific transformation to be |
| | performed during a particular stage and |
| | sequence. |
| IF_DATA_TRANSFORM_COL | Lists SQL Where clause conditions for |
| | complex data transformations on individual |
| | columns. |
| IF_DATA_TRANSFORM_MAP | Contains transform maps for mapping-type |
| | data transforms and certain error checks |
| IF_DATA_TRANSFORM_PAIR_MAP | Defines a ‘dual map’ that allows for two |
| | conditions to be applied to a single transform |
| IF_DATA_TRANSFORM_TYPE | Lists transform types by ID and describes the |
| | associated transform function. |

Error and conflict processes identify faulty or conflicting data and remove data from tables to prevent them from proceeding further in the integration process. Error records are moved to specific error tables. Additionally, data quality tracking is performed to ensure accurate system operation.

Data Quality Tracking (DQT) provides insight into the integrated data of a system deployment, as well as the operation of the current metadata-driven rules and processes by which the data is integrated. DQT data can be thought of as output “metadata” using the standard definition of the term: data about data. (This is distinct from the configuration metadata that is generated and/or defined by the user as an input into the integration process.) The DQT data describes qualities and attributes of the data as well as the workings and efficacy of the integration process.

DQT is part of the overall consolidation process, where data from multiple sources are combined, and where there are multiple sources of data for the same entity (an asset, a user, etc.) the system allows for prioritized reduction down to a single “gold” record, the “best view” of the entity.

DQT tables are structured in a set of star schemas to support dynamic, open-ended growth of data and structures. DQT is organized into categories by the nature of the data, the nature of the operation to determine the data, and the granularity of the data. All DQT tables start at the entity level, where typical entities supported by the system out-of-the-box are Asset, User, Contract, etc. As such, a particular implementation may have a set of DQT tables related to Assets, another set of DQT tables related to Users, etc. Each set can be enabled or disabled in configuration metadata, and within a set different features and functions can be enabled or disabled in configuration metadata.

As an example, the following description describes only DQT tables for Assets as a case study, but it is important to note that the solution is not restricted to only Assets.

The Asset DQT tables are organized by granularity of the data being described. For example, some DQT functions operate on specific, individual fields/columns in a record, while some DQT functions are applicable to the full record/row of data, etc. The granularity organization (with its standard table prefix) is as follows:

| Data | Standard DQT table |
|---|---|
| Granularity | prefix |
| Column | QCOL |
| Row | QROW |
| Source | QSRC |
| Source Match | QMAT |
| Summary Group | QSUM |

Within each table, there may be multiple columns, which may be related to one or more DQT functions. There may or may not be any relationship between the columns, except for the fact that they operate at the same level of granularity.

Column DQT tracking tracks information about each individual field on each individual record. The items that are tracked in a column-wise fashion are:
1) Conflict—(Y/N flag)—Are there multiple, distinct non-null (i.e. non-empty) values from the various sources for this field for this record? Note that the idea of a null conflicting with a non-null is supported to allow additional insight into potential data sparseness (missing data)
2) Populated Source—(Source ID value)—This stores which source's value was actually used in the consolidated record. This is typically the highest priority source for the column that had a non-null value.
3) Populated Priority—(sequential value)—This stores the relative priority of the source that was actually used in the consolidated record. For example, if the source with the second highest priority was used for a particular value in a particular record, the populated priority value for this column in the DQT record would be “2”.
4) Populated Weight—(Numeric scale value 1-100)—Where weighting is used instead of explicit prioritization for determining prioritization, this stores the weight of the populated value

During the consolidation process, the integration framework determines conflicts by getting the count of distinct non-null values from all sources for a particular column in a particular record. If that count is >1, then this is considered to be a conflict (“Y”) else it is a not a conflict.

Populated source, populated priority and/or populated weight are determined at the time that the multiple source values are reduced down to a single value during consolidation. At the time that the correct source value is determined, the source ID, prioritization and/or weight are also available, and these values are stored in the related DQT table.

With column-wise tracking, the system can answer questions like the following:
1) How many (and which specific) assets have conflicting values for <critical field>? (Such as asset name, asset tag, serial number, etc.)
2) Which assets were populated with data from <source> for <field>?
3) Which assets were not populated with the highest priority source for <critical field>?
4) Which assets were populated with a field with weight less than <threshold>?

Not only can the aggregate counts be determined, but the system facilitates drilling to the specific records and/or individual fields in question, as well as back to the individual sources that make up this consolidated record.

Row DQT tracking tracks information about individual records at the record level, not at an individual column level. The items that are tracked in a row-wise fashion are:
1) Row conflict—(Y/N flag)—This can be thought of as a roll-up of all column conflicts. That is, if any individual column has a conflict, then Row conflict is Y, else row conflict is N.
2) Source Count—(numeric value)—This is the number of sources that were associated and consolidated for a particular record. For example, if data about a particular asset is found in 3 sources (from association), then the source count for the consolidated record is “3”.

During association, the primary key of the final target table for the entity (a.k.a., entity ID i.e., ASSET_ID for assets) is assigned and linked between different source records, where the association rules determine that these records are referring to the same entity. Thus, at the end of association, the records in the asset staging table will all have an assigned ASSET_ID, and records that have the same ASSET_ID are referring to the same entity, even if the records come from different sources.

The Source count is determined by counting the number of distinct sources for each individual entity ID in the staging table.

Row conflict is determined by counting the number of column conflicts found for a particular record. If this number is >0 then Row conflict=‘Y’ else row conflict=N. Thus, row tracking is performed after and is dependent on column tracking.

With row-wise tracking, the system can answer questions like the following:
1) Which assets came from only 1 source?
2) Which assets came from <threshold> number of sources or more?
3) Which assets have a conflict in any column being tracked for conflicts?

Source DQT Tracking tracks information about the associated sources for each individual record. The item that is tracked in a source-wise fashion is:
1) Has source record—(Y/N flag)—For each possible source ID, this flag stores whether or not an individual consolidated record had a record from that particular source.

As described previously, after association every record from each source for the entity will have an assigned entity ID in the staging table. Thus, for each entity, the system determines the individual sources in which data for this entity was found by selecting the entity ID and the source ID. The system also actively stores the negative flags (i.e., the source IDs where a record was not found for a particular entity) since this simplifies the reporting of negative data, which can be of interest to a customer.

With source-wise tracking, the system can answer questions like the following:
1) Which assets came from <specific source>?
2) Which assets did not come from <specific source>?
3) Which assets were found in <source(s)> but not in <other source(s)>?

Source Match DQT tracking tracks information about the relationship between source pairs for each individual record. This data is determined and stored at multiple levels of granularity in the source match DQT table. To understand source match tracking, the concept of Association is described first.

Association uses metadata-driven rules to find records between different sources that are in fact the same entity. Typically, there will be a prioritized set of match rules for linking between sources. For example, for asset association, the metadata may be configured to match using the following columns, in order:
1) Asset Name, Asset Tag and Serial Number
2) Asset Name and Asset Tag
3) Asset Name and Serial Number
4) Asset Tag and Serial Number
5) Asset Name
6) Asset Tag
7) Serial Number

What this means is, the system first tries to find any matches between, say, source 1 and 2 by matching on Asset Name, Asset Tag and Serial Number. Any assets with matches on all three attributes will be assigned the same Asset ID in both sources. Then, the system matches just on Asset Name and Asset Tag, then just on Asset Name and Serial Number, etc. down through the priority list. Note that this will waterfall down through all the sources, though the relationship between each pair of sources can use different association rules, as configured in metadata.

Once a pair has been found and the asset ID is assigned, that record will not be reassigned a different asset ID based upon a later, lower priority rule. So if an asset matches Asset 1 using Asset Name and Asset Tag, it will also be considered Asset 1, even if it also happens to match Asset 2 on Serial Number alone (since Serial Number match is a lower priority match condition.)

Source Matching DQT Tracking has three major facets to it:
1) Direct rule match
2) Direct source match
3) Indirect source match

Direct rule matching is, in essence, tracking the results of the association rule matching described above. (Technically, it is re-evaluating each rule independently, for reasons described later.) Thus, direct rule matching will store, for each individual asset, whether there is a match between the sources in question for a particular association rule, i.e. was there a match between source 1 and 2 for Asset ID 1 when matching on Asset Name, Asset Tag and Serial Number? Metadata controls which source pairs are evaluated.

Direct source matching stores the following information:
1) Source combination—(numeric pointer to description of source pair)—the pair of sources under consideration
2) Match column collection—(numeric pointer to set of columns)—the column being evaluated for matching (i.e. Asset Name, Asset Tag and Serial Number would be the match column collection for rule 1 above)
3) Has Match—(Y/N flag)—whether or not the source combination (pair) has a match for the particular rule under consideration
4) Rule Order—(numeric value)—What the rule order is, i.e. the system store the relative order of rules as they are evaluated, to know which rules are evaluated first
5) Is First Rule Match—(Y/N flag)—For rules that do match (Has Match=Y) the system identifies the first rule to match. This is because more general rules will evaluate to Y if more specific rules evaluate to Y (i.e. if an asset matches on the Asset Name, Serial Number combination, it will also match on Asset Name by itself and Serial Number by itself, but it is most interesting to know which rule matched first)

For Direct Rule Matching, the system reevaluates each linking association rule independently using the same logic as association, and store the results (both positive and negative) in the Source Match DQT table.

With Direct Rule Matching, the system can answer questions like the following:
1) Which assets had matches between sources using <specific rule criteria>?
2) Which assets had matches between sources using only <less stringent criteria>?
3) Which assets did not match any criteria between sources?

Direct source matching is a single record distillation of all of the individual direct rule matches for a particular source pair for a particular entity. That is, if there are any direct rule matches between sources for a particular record, then there is a direct source match, else there is not a direct source match. In other words, direct source match indicates whether there is a direct (source-to-source) match between sources. (There is also the idea of an indirect match, discussed below.)

Additionally, beyond the types of information tracked for Direct Rule Matching, the system also tracks another piece of information:
1) Is Associated—(Y/N flag)—This indicates whether or not there actually was an association between the sources in question.

This is an important distinction between the evaluation of association and the re-evaluation of Source Matching DQT. Source Matching indicates what can match, and association and consolidation indicate what did match. Because of potential ambiguities and/or other issues in incoming data, this can be a very real difference that can be of significant interest to a customer. (For example, a single asset in one source could match ambiguously to multiple records in a different source. Only one will be the match from the association point of view (i.e. Is Associated=Y), but both will have a direct source match. This can indicate a data error or other issue.)

Direct Source Matching Has Match takes the direct rule matching records as an input, and creates a single Y/N flag based upon whether any individual rule had a match. Is Associated takes the Source Tracking (QSRC) data as an input, where Is Associated is set to “Y” where the entity is found in both sources, otherwise “N”.

With Direct Source Matching, the system can answer questions like the following:
1) Which assets have a direct relationship between sources?
2) Which assets have no direct relationship between a pair of sources?
3) Which assets have a direct relationship between a pair of sources, but still were not actually associated between those sources?

Indirect Source Matching is the final piece of the source matching puzzle. Indirect Source Matching determines assets that have been associated (as determined from Source Tracking) but do not have a direct relationship (as determined by Direct Rule/Source Matching above). Indirect Source Matching uses the same flags as direct source matching (Has Match, Is Associated, etc.), but has a different match type indicator, so that it is clear that the record is for indirect matching, not direct source or direct rule matching.

An asset can get indirect matches via a few different scenarios. For example, consider a single asset (“Asset 10”) and three sources for asset data. Presume that Asset 10 in Source 1 has a match to Source 2. This is a direct source match, and whichever rule(s) matched are direct rule matches. But due to the association rules that can differ from source to source, say that no direct match was found between Source 1 and Source 3. However, if the Asset 10 record in Source 2 matches an asset record in Source 3 (which can be according to rules that are particular to this pair of sources) then this same Asset ID will be assigned to the Source 3 record. Thus, Asset 10 will be found in all 3 sources, but there is no direct relationship between Sources 1 and 3 for this asset. Thus, all direct rule match and direct source match records will indicate Has Match=N, even though Is Associated=Y.

Thus, the system considers this to be an Indirect Source Match between sources 1 and 3, because it did match, even though there wasn't a direct relationship. The relationship can be through an intermediary source like above, or an even more circuitous path.

Indirect Source Matching takes the Direct Source Matching and Source Tracking data as input. If an entity is associated between a source pair but does not have a direct match between that pair, then Indirect Source Match Has Match=Y, else Has Match=N.

With Indirect Source Matching, the system can answer questions like the following:
1) Which assets are associated but do not have a direct relationship between sources?
   The interest in this question falls into two categories:
      a) If the assets should have a direct relationship between sources (i.e. the expected overlap between sources is high) this may be an indicator of poor quality and/or sparse data.
      b) If the assets are not expected to have a direct relationship (i.e. there are few or no direct association rules between the sources that could have been used to match) then indirect source matching is a clear demonstration to the customer of the comprehensiveness of the solution, as finding and exploiting this type of relationship is considered to be a “challenging” problem (the existence of which is sometimes not initially comprehended by the customer).

Summary group DQT tracking is somewhat different in nature from the above DQT types. The concept of a summary group is a set of records of an entity type (i.e., Assets) that have a (potentially arbitrary) relationship with each other. The system does not impose any specific relationship, and intentionally keep the structure and relationship as simple as possible, to make the capabilities flexible while keeping the reporting simple.

The system uses summary groups as part of aggregate table detail, where the aggregate table contains individual “category” records with counts of records that have a particular quality in common to them. The system uses summary groups in several aggregate tables, including a Source Comparison aggregate table, which rolls up the DQT data described above in various ways to simplify reporting.

Examples of specific summary groups used in a typical Source Comparison aggregate include:
Assets from Tivoli
Assets In SMS Not In Asset Center
Total Match Between SMS and Asset Center using all Methods and Keys
Detail of Association Rules Between SMS and Asset Center: Asset Name/Serial Number Match
etc.

But again, there is no specific limitation on the contents of a summary group. So these would be equally valid summary groups:
Assets that came from a single source and have a last activity date greater than 3 months old
Assets in a particular department that have no primary user
Assets that have an Asset Name that begins with the letter M
And so on

Basically, if the item can be queried for in the database with freeform SQL (or even multiple SQL statements), the system can place it in a summary group, and then aggregate it, report on it and (most importantly) drill to it to see the original records in question.

As described above, a Summary Group is a group of records with an arbitrary but deterministic relationship. Without summary groups, grouping records arbitrarily so that they can be reported on simply and aggregated can be a significant challenge that typically puts pressure on the reporting solution to execute and/or replicate the business logic of the framework. This violates the separation of concerns, where the reporting solution should focus on the presentation of data, not on the generation of data.

Thus, at its core, a summary group is the addition of a single layer of indirection allowing for the assignment of a unifying summary group ID to a set of ID pointers (references) to the original records of interest. The system stores the summary group ID and the entity ID pointers in the summary group table.

Summary groups are a means to an end. The meaning of the groups is what provides value. Summary groups are used for:
Source Comparison—aggregated counts of the various direct source/indirect source/direct rule match records determined above
Consolidation counts—aggregated counts of the records that satisfy various conditions, such as records only from single sources, records from 2 sources, records from 3 sources, etc.

In both of these cases, reporting on the above in a clean, simple and extensible (non-hardcoded) way would have been extremely difficult and/or impossible without summary groups. Further, summary group applications include the use of an aggregate “Y/N” report allowing for navigating between all possible permutations of source combinations (i.e., assets with records in sources A, B and D and not in sources C, E and F).

Union tables store copies of records that originate in multiple, disparate tables, and then create an action that populates this table. One example of a union table instance is table containing a union of error records related to assets (E_ASSET table). (Note that union tables don't have to be unions of error tables, but this is the primary motivating case.)

Note that the structure of E_ASSET is focused on the high priority columns for assets (ASSET_NAME, SERIAL_NUMBER, etc.), not every possible asset column. The reason is, every column mapping adds complexity from a metadata configuration perspective; so focusing on the most important columns (as well as those most likely to participate in error checks) gives important focus. Also, the more columns in the union table, the more sparse the records will probably be as each source table may only have a subset of the union columns. The list of proposed columns were determined by reviewing the most common columns on various reports.

In one embodiment of the invention, there are four metadata tables related to union tables:
IF_UNION_TABLE—Initial table that indicates what tables are union tables to be processed
IF_UNION_TABLE_MAP—List of tables that map into the union tables
IF_UNION_TABLE_COL_ALIAS—Column names to be used in mapping (to populate IF_UNION_TABLE_COLUMN_MAP)
IF_UNION_TABLE_COLUMN_MAP—Source table and column to union table and column mappings

Each table as its own purpose. The only table that must be populated by the system configurator to turn on this functionality is IF_UNION_TABLE.

From this table, UnionTableAction knows:
the union table
the type of table (ERROR in this case)
the type of entity (ASSET in this case)
the prototype table that maps into the error table

From this information, UnionTableAction determines which tables should be mapped into E_ASSET. Since this is an ERROR type union table, then the candidates are: every error table that corresponds to a table that maps into STG_F_ASSET. Now, all of those relationships can be found in metadata (IF_TABLE_COLUMN_MAP, IF_DATA_ERR_CHK_TABLE, etc.). UnionTableAction traverses those relationships and finds the appropriate tables, which are populated in IF_UNION_TABLE_MAP.

As shown below for CSC, there are 2 error tables, at import and one at staging) that correspond to STG_F_ASSET. Table 1 is an example of a union table that was populated automatically by UnionTableAction.

In Table 1, besides the table mappings, there are a couple of other columns including:
INCLUDE_SRC_IN_UNION is a simple Y/N flag for whether this table should in fact be included in the union table.
INCLUSIVE_TRANSFER_FILTER allows for a free-form condition to be applied to the transfer into the union table
INCLUDE_SRC_IN_UNION enables UnionTableAction to determine if the table should be mapped.

Union Tables may be used as follows:
1) Configurator inserts IF_UNION_TABLE seed record
2) Sync is run including UnionTableAction to populate derivable metadata
3) Contents of metadata in DB are reloaded back into spreadsheet
4) Configurator uses this as new baseline for tables, and makes tweaks as necessary to get union tables to populate

Continuing, IF_UNION_TABLE_COL_ALIAS is used to create column aliases. Since the system knows the union table (and its columns) and knows the prototype table (and its columns), the system starts automatic mapping of prototype columns to union columns. This is an actually an intermediate mapping table, that is used to handle column mappings as well as create column aliases. The aliases are just other names for the columns. Table 2 depicts a brief sample of this mapping.

Any union table map table column that maps to the prototype table which has the column alias name above, is mapped to the corresponding union table column in the union table.

In one specific example of “ASSET_NAME”, any column that maps (via IF_TABLE_COLUMN_MAP or the error extension) to STG_F_ASSET (the prototype) ASSET_NAME, is mapped to E_ASSET.ASSET_NAME.

Within the mapping process there is an alias priority, which means that the system uses a hierarchy of mappings, and for each table to be mapped in, the system continues from highest priority to lowest priority until the system finds a column match.

Also, the system uses an ALIAS_MODEL with a value of “PROTOTYPE”. What this means is, the system maps columns that map to the PROTOTYPE table column with the name of COLUMN ALIAS. It is also possible to have an ALIAS_MODEL of “SOURCE”. With this, the COLUMN_ALIAS values are referring directly to columns on the source tables (which might have completely different names, such as “HOSTNAME” at an import level). However, it is expected that using the PROTOTYPE alias model will be the most common way to do this, as an import level HOSTNAME column will still get picked up and mapped correctly to E_ASSET.ASSET_NAME, as long as in IF_TABLE_COLUMN_MAP the import HOSTNAME column is mapped to STG_F_ASSET.ASSET_NAME (the prototype).

ALIAS_PRIORITY set 1 is automatically populated, using just the exact column names of E_ASSET. Any additional mappings, or tweaks, need to be added as additional sets. For example, certain tweaks were preformed above, where alternate column names have been added for PHYSICAL_STATUS_NAME and FINANCIAL_STATUS_NAME. Thus, if a mapped table has a column that maps into either of these, it will be mapped into the corresponding union column. (If a table has both, the alias priority determines the actual one used).

All of the above forms an intermediate mapping table. At the end of this process, the system has to make a determination of source tables and columns to be mapped explicitly into the union tables and columns. So this could (in theory) be calculated on the fly from the above, but instead the system takes the explicit route and store the results of the column mappings in another metadata table, IF_UNION_TABLE_COLUMN_MAP.

UnionTableAction takes a first stab at it, and Table 3 depicts a representative sample.

So at the end of all of this, E_ASSET is populated with, in the above case, records mapped from both ERR_STG_F_ASSET and ERR_IMP_ASSET. Thus, the system may drill from an error overview report and see the actual records (or rather their union table proxies, but that should be transparent to the end user.) Error functions provided include:
Checking for duplicate values
Checking for bad data values
Checking for non-numeric values
Checking for invalid length values
Checking for invalid values
Checking for custom validation
Checking for bad data values
Identifying latest scan date per S/N
Handling errors

Conflict functions provided include:
Checking for conflicting data for the same asset as reported by different sources

### Metadata Tables for Error and Conflict Functions

| Table Name | Description |
|---|---|
| IF_DATA_ERR_CHECK | Each row defines the error check to be |
| | performed. |
| IF_DATA_ERR_CHECK_TYPE | Describes the built in error checks that can |
| | be performed and their associated ID number. |
| IF_DATA_ERR_CHK_DETAIL | Contains error check parameters |
| IF_DATA_ERR_CHK_TABLE | Cross-indexes the source table with the error |
| | table. Each row Relates a source table to a |
| | corresponding error table, and the additional |
| | column name that will identify the error in the |
| | error table. |
| IF_DATA_ERR_CODE | Lists error codes by ID and describes the |
| | associated error function. |
| IF_DATA_ERR_RANK_MAP | This table allows for the configuration of error |
| | checking based on a secondary field. For |
| | example, de-dup can be performed upon a |
| | Serial Number but use Status as secondary |
| | criteria for de-duping. Serial number |
| | duplicates are found and the status values |
| | can be ranked to determine which of the |
| | serial number records are kept. |
| IF_DATA_ERR_CHECK | Each row defines the error check to be |
| | performed. |
| IF_ERR_RESOLUTION_TYPE | List of action to occur when a data error is detected |
| IF_DATA_ERR_CHECK_TYPE | Describes the built in error checks that can |
| | be performed and their associated ID number. |
| IF_CONFLICT_FLAG_CFG | Allows setting a conflict flag and its parameters |

During association, the sync process finds and links records that refer to the same entity, an “entity” in this case defined as an asset, a software item, a user, and the like. Data comes from different sources, but the often data concerns identical entities; association finds the links between records and gives each record the same identifier in the staging tables.

Association is also used to create the IDs that are the PKs and FKs for the final target tables. Some association actions create (and associate) new records where they are needed. Association is invoked on data that is already in the staging tables. However, because a process stage ID can be specified, an association step can be performed at any point in the process.

For example, at the end of the association process, it is clear what record from source B refers to asset 10 from source A. Association functions include:
Assign key identifiers
Link matching assets by selected column values
Merging keys
Creating placeholders
Copy columns
Execute custom procedures

Import table association is another type of association made in the Integration Framework. Import tables define the relationship between imported tables and support a variety of import table relationships such as:
Single import table or multiple non-related import tables being transferred to distinct staging tables
Multiple import tables in a parent-children relationship with inner or outer join constraints between each parent and child (called an import group)
Multi-hierarchy import group relationships with prioritized joining between import groups
No explicit limit on number of import tables, import groups, import group relationships or depth

### Metadata Tables for Association

| Table Name | Description |
|---|---|
| IF_ASSOCIATION | Contains the parameters used for |
| | associate functions. One row defines |
| | a single association between two |
| | columns. |
| IF_ASSOCIATION_TYPE | Lists association types by ID and |
| | describes the identified association |
| | function. |
| IF_IMPORT_TABLE | Defines the relationships between |
| | various import tables from the same |
| | source, and aggregates tables into |
| | import groups. |
| IF_IMPORT_TABLE_PARENT | Defines a uni- or bi-directional |
| | relationship between import groups |
| | defined in the IF_IMPORT_TABLE |
| | metadata. |

The Key Merge action assigns unique values from a sequence to the set of distinct values in a specified, configurable set of columns in a table. If the same set of values occurs multiple times in the table, all occurrences of the distinct set of values are assigned the same key value. Provided functions include:
Temporary table creation and dropping
Selecting distinct values from the source columns.
Updating back to the primary table
Joining the candidate key columns.

In some cases, the temporary table is not really a temporary table but an existing table; in this case, it is not created or dropped.

### Metadata Tables for Key Merging

| Table Name | Description |
|---|---|
| IF_KEY_MERGE_COLUMN | This table identifies the columns used |
| | for evaluation in the key merge process. |
| IF_KEY_MERGE_TABLE | This table identifies the target table, |
| | column output and input sequence for |
| | the key merge process |

Consolidation processes function to combine the data to obtain a Gold data record for a unique asset, user, or other entity by defining the priority of data coming from a particular source over another. Consolidation is performed column by column, meaning that the value for one column may be taken from source A if possible, and if not then from source B, source C, and so on, while for other columns the order may be reversed.

In one embodiment of the invention, consolidation is performed by creating a plurality of tables, where each table contains assets comprising the same attribute, e.g., a narrow table for each attribute such as asset name, serial number, and so on. Each of these tables is consolidated into a temporary table using a single SQL statement. The temporary tables are then joined to form a multi-dimensional table containing the consolidated records (golden records). Using this procedure is significantly faster in achieving the golden records rather than processing the data on a record by record basis. Provided functions include:
Weighting of column and source combinations
Flagging conflicting data during consolidation
Identifying when a column in a record is populated by a non-primary source.

### Metadata Tables for Consolidation:

| Table Name | Description |
|---|---|
| IF_CONSOLID_RULE | Allows application of a consolidation rule to |
| | a column |
| IF_CONSOLID_TABLE | Identifies the source and destination tables |
| | for consolidation, along with various |
| | optional and configurable behavior |
| | options. |

The system possesses the capability segregate an outsourcer's multiple clients (referred to herein as tenants) by assigning unique identifiers to each individual client's data. This way, queries and subsequent reporting on IT assets can be filtered for display for each individual tenant only, while an outsourcer organization may opt to make distinctions based on its own hierarchy.

Tenant configuration within the Integration Framework consists of identifying a client and associating that identifier with asset data as it enters the system schema and passes through the import, staging, and target phases. Provided functions include:
Tenant and sub-Tenant definition

### Metadata Tables for Tenant Configuration

| Table Name | Description |
|---|---|
| IF_TENANT | Used to define platform tenants for |
| | a leveraged solution |
| IF_TENANT_DATA_PARTITION | Lists the various groups that may |
| | exist within a single tenan |
| | organization |
| IF_TENANT_GROUP_MAP | Defines the relationship between a |
| | tenant group configured in the |
| | integration framework and a |
| | MicroStrategy group |

Closely related to the creation/deletion processes and tables shown earlier, Data Structure Configuration and Definition tables identify data structures and how they are related. Provided functions include:
Definition of core The system schema tables
Describes the relationship of this version of the Integration Framework to prior versions
Core table and column configuration
Data entity definition

### Metadata Tables for Data Structure Configuration and Definition

| Table Name | Description |
|---|---|
| IF_SCHEMA_ROLE_MAP | Lists the core schema roles |
| IF_CORE_CONNECTOR_COL | Defines the standard CON_* tables in the |
| | Integration Framework |
| IF_CORE_DEPENDENCY | Lists the key relationships and table |
| | dependencies between core The system |
| | tables |
| IF_CORE_ENTITY | Lists The system-defined categories (data |
| | entities) of asset data |
| IF_CORE_LEGACY_COLUMN_MAP | Matches tables and columns in the |
| | current version of the Integration |
| | framework to prior versions |
| IF_CORE_LEGACY_TABLE_MAP | Matches tables in the current version of the |
| | Integration framework to prior versions |
| IF_CORE_TABLE | Allows configuration of OOTB tables |
| IF_CORE_TABLE_COLUMN | Allows configuration of OOTB columns |
| IF_ENTITY_TYPE | Lists implementation-specific (custom) |
| | categories (data entities) of asset data |
| IF_ENTITY_TYPE_TABLE_MAP | Matches a data entity and integration process |
| | stage to a custom table |

Rulesets are used in Multi-Tenant scenarios to allow for the conditional application of a specific action. This was implemented in the system to facilitate metadata configuration via the reuse/reapplication of existing rules across multiple platform tenants when applicable.

A rule is a generic term for a unit of configured metadata intended to drive a specific action, i.e. association rule or data transform rule. A single rule may correspond to one or more specific metadata records in one or more metadata tables, based upon the particular configuration options of the action in question. A single rule should not be interpreted to span multiple actions, even of a single type (i.e. 1 data transform=1 rule.)

An action type is a type of action that is being performed. For the purpose of rulesets, the action types are “chunky”, so multiple specific action classes may be considered the same action type. For example, Link action and Assign action are both considered of the same type “Association” action.

The currently identified action types to be used for tenant rulesets are:
a. Data transform
b. Association
c. Consolidation
d. Validation
e. Source Match tracking
f. Custom Conflict Flags

A ruleset is a collection of rules of a single type that have been determined by the human configurator to have a relationship such that they should be applied (or not applied) as an atomic entity. That is, either all rules in a ruleset are applied for a specific tenant, or none are. A ruleset is identified by its type and identifier (ID). The ID does not need to be unique across rulesets of different types, so for example there may be association ruleset 1 as well as data transform ruleset 1. Rulesets of different types should be viewed as completely independent of each other, and thus there is no inherent relationship between rulesets of different type even if they have the same ruleset ID.

The action type for a specific rule or set of rules is referred to as a rule or reset type. Each ruleset has a specific type, which is one of the action types identified above.

The system systematically applies the concept of a ruleset. In one embodiment of the invention, where the system operates in a non-multi-tenant mode, almost all actions configured in metadata are directly applied to the customer data without implicit condition. In an embodiment that operates in a multi-tenant mode, there shall be an additional level of indirection between the rules and actions configured in metadata and the various tenants' data. All metadata rules (transforms, associations, etc.) shall have a mandatory attribute of a ruleset ID.

A tenant will not be assigned directly to a rule, but rather will be associated with one or more rulesets. In this way, specific, related groups of rules will be applied to tenant data, and multiple tenants can share the same rules without requiring massive duplication of metadata rule configuration. Further, additional tenants shall be able to be introduced into a live system with little or no mandatory metadata configuration, provided that the new tenant's sources and rules conform to existing definitions within the system.

Every metadata rule has a ruleset ID. All rules of the same type (i.e. association or data transform) and same ruleset ID are applied (or not applied) together to the same set of tenants as configured in metadata. (It is not necessary for this ruleset to be atomic in the ACID transactional sense.)

A ruleset has a type, corresponding to the type of metadata rules it represents. A ruleset also has an ID that is unique within the type. A tenant can be assigned one or more rulesets of a type. Tenants can be assigned multiple rulesets, and the same ruleset can be assigned to multiple tenants.

It is an explicit consideration that the amount of configuration that the end customer must perform in order to introduce a new tenant into an existing deployment shall be minimized where possible. Force changing configuration on an exception basis only (i.e. where a new tenant needs alternate behavior that has not yet been configured). Encourage default behavior, rule and ruleset reuse to reduce complexity and increase manageability of a large deployment.

There is a default ruleset for each type (ID 1). All tenants inherit the default ruleset, even if it is not explicitly configured. In this way, a new tenant with “typical” behavior (as configured for the sources within a deployment) can be introduced into a deployment and start working “out of the box” with no additional configuration required.

In the interest of having a “single line of code” for both multi-tenant and non-multi-tenant system deployments, the aforementioned ruleset behavior is only applicable for multi-tenant scenarios. Thus, the activity of multi-tenant rulesets and their behavior is governed by at least one global parameter that enables/disables rulesets. This may be the same global parameter that enables/disables multi-tenancy in general.

In terms of implementation, the addition of rulesets in a multi-tenant deployment has the primary effect of adding a (additional) WHERE clause to the various generated SQL statements. For example, in an Association link action, the clause shall also match on tenant_IDs and restrict the set of affected tenant IDs to those that are associated with the ruleset. The ruleset determines which tenant IDs are applicable for the particular rule. Here are three example clauses:
Single tenant ID: WHERE . . . (AND A.tenant_id=B.tenant_id AND B.tenant_id=X)
Multiple tenant IDs: WHERE . . . (AND A.tenant_id=B.tenants_id AND B.tenant_id IN (X, Y, Z))
Default ruleset—all tenants: WHERE . . . (AND A.tenant_id=B.tenant_id)

Other actions will be affected in a similar manner. Functions provided include:
Defining the ruleset
Applying the defined ruleset to selected tenants.

### Metadata Tables for Rulesets

| Table Name | Description |
|---|---|
| IF_ASSOC_RULESET | Defines a rule (reusable, semi-standard |
| | configuration) related to the association of data |
| | from multiple sources |
| IF_ASSOC_RULESET_TENANT | Applies a defined association rule to a |
| | tenant's data |
| IF_CONSOLID_RULESET | Defines a rule (reusable, semi- |
| | standard configuration) related to consolidation |
| IF_CONSOLID_RULESET_TENANT | Applies a defined consolidation rule |
| | to a tenant's data |
| IF_CON_FLAG_RULESET | Defines a rule (reusable, semi- |
| | standard configuration) related to |
| | setting data conflict flags |
| IF_CON_FLAG_RULESET_TENANT | Applies a defined conflict flag |
| | configuration rule to a tenant's data |
| IF_DT_RULESET | Defines a rule (reusable, semi- |
| | standard configuration) related to |
| | data transformations |
| IF_DT_RULESET_TENANT | Applies a defined data transform |
| | rule to a tenant's data |
| IF_ERR_CHK_RULESET | Defines a rule (reusable, semi-standard |
| | configuration) related to data error checking |
| IF_ERR_CHK_RULESET_TENANT | Applies a defined error check rule |
| | to a tenant's data |
| IF_SRC_MAT_RULESET | Defines a rule (reusable, semi- |
| | standard configuration) related to |
| | source matching performed in |
| | IF_SOURCE_MATCH_CFG |
| IF_SRC_MAT_RULESET_TENANT | Applies a defined source matching |
| | rule to a tenant's data |

A remaining set of miscellaneous tables do not easily fit into a defined process, but are configurable within the Integration Framework. Provided functions include:
Logging of Integration Framework process events
Setting of global data parameters

### Metadata Tables for Miscellaneous Items

| Table Name | Description |
|---|---|
| IF_SYNC | Defines the start and end of a data sync (data |
| | integration) |
| IF_SYNC_EVENT_LOG | Identifies the start, end, and various |
| | characteristics of a single action within a |
| | data sync |
| IF_SYNC_EVENT_LOG_LEVEL | Lists logging levels to be used for a data sync |
| IF_SQL_LOG | Shows the SQL statement(s) that occur |
| | during a process stage in the data |
| | integration sync |
| IF_MAPPING_LOG | Logs the ‘before and after’ state of data |
| | that has been transformed in some way |
| IF_GLOBAL_PARAMETER | A simple key-value table to hold pieces of |
| | information that are needed by other |
| | metadata processes but are desirable to |
| | be configurable rather than hard-coded. |
| IF_CORE_GLOBAL_PARAMETER | Lists standard column naming and data |
| | typing to apply to applicable tables |
| IF_HW_CATEG | Lists common machine models and OS |
| | names and matches them to a machine type |
| | and class |

IT Outsourcers manage IT assets for their customers and generate revenue by billing the customer for assets under management. Such billing may require billing reconciliation.

At its core, billing reconciliation has three primary goals:
1) Identify underbilled assets—Assets which could be billed for, but which are not being billed (this is dollar-for-dollar lost revenue). The assets may actually be under management but not being billed (working for free) or may be eligible management candidates that the ITO is not managing (missed opportunity)
2) Identify overbilled assets—Assets that the ITO is billing for, but should not be. (This represents a liability to the ITO outsourcer, as overbilling may additionally incur penalties and/or threaten the IT management contract). The assets may be under management mistakenly (as the ITO may only have authority to manage a subset of assets) or the assets may no longer be active assets but have not been purged from the billing system
3) Provide insight and justification for currently billed (and non-billed) assets—If the end customer challenges the ITO bill, the ITO needs to justify the bill, by demonstrating which assets were included, how they were determined to be active and eligible assets, etc. In some cases, lack of insight and/or ability to justify a bill has led end customers to systematically shortchange the payment of the ITO bill, again representing lost revenue.

Billing reconciliation leverages many aspects of DQT (particularly source tracking and source match tracking), as well as other information and business rules, to put each consolidated asset into a billing category.

Considerations that typically are inputs to this categorization include:
1) Asset is in a source that is authoritative for billing (i.e. billing system)
2) Asset is considered to be a billable asset by the billing system (a.k.a. financial status)
3) Asset is in one or more asset management and/or asset discovery systems (other than the billing system)
4) Asset is considered to be an eligible asset for management (referred to as “In Scope” assets). The rules for determining an in-scope asset may vary significantly from customer to customer, and may include:
   Type and class of asset
   Physical location of the asset
   User(s) of the asset
   Associated department of the asset
   Other properties of the asset (operating system, manufacturer, etc.)

These various inputs form a matrix, where each cell of the matrix represents a billing category, such as “Verified as Billable” or “Underbilled by Scope”.

Note that the system determines both a major category, such as:
Verified
Underbilled
Overbilled
Unable To Verify

A sub category, such as:
Verified as Billable
Underbilled by Rogue (a rogue asset is an asset not known to billing system)
Underbilled by Scope (a known asset that is not being billed but is in scope and qualifies to be billed)

And a billing category cause (i.e. the “reason” the particular category was assigned), such as:
Rogue Asset
Scope Mismatch
Missing Scope

Table 4 depicts the relationships of the various inputs and outputs for billing categorization.

As discussed previously, the gold record is the final, consolidated record that represents the best view of the entity by combining and consolidating the data from multiple sources. As discussed previously, DQT allows for simple reporting of the number of sources that constitute a gold record, and their relationships. However, the system stores of a copy of the gold record in the staging table in staging format. This allows for intuitive reporting where a user can drill from a standard (gold) record report to a source detail report to see a specific gold record plus all the records from the various sources that were consolidated to the gold record, in a simple table layout. This is a tremendous source of information and benefit to the customer as it shows in striking detail the records from the various sources that are familiar to the customer, plus their relationships which can be verified through simple visual inspection (i.e., see the Asset Name matches, see the Serial Number matches, etc.)

This is particularly effective with Billing Reconciliation, since a simple visual presentation of the related source records that affords easy verification by the customer instills confidence in general in the reported results.

While the foregoing is directed to embodiments of the present invention, other and further embodiments of the invention may be devised without departing from the basic scope thereof.

1. A method of gathering and organizing data pertaining to an entity comprising:
extracting the data from a plurality of data sources associated with one or more tenants;
organizing the data into connector files having a predefined structure and associating the data in each connector file with a tenant parameter; and
storing the connector files in memory.

2. The method of claim 1 wherein the extracting step further comprises:
selecting a tenant from a plurality of tenants, where each tenant comprises a plurality of data sources.

3. The method of claim 1 wherein the connector files are either dynamic connector files or generic connector files.

4. The method of claim 1 wherein the organizing step comprises:
adding meta data to the connector files comprising at least one of a tenant code, data partition code, source code or a native identifier.

5. The method of claim 1 wherein at least one connector file is a dynamic connector file and the organization step further comprises:
creating a configuration file associated with the dynamic connector file, where the configuration file comprises parameters for the dynamic connector file.

6. The method of claim 5 wherein the configuration file is an XML file.

7. The method of claim 1 further comprising:
accessing the connector files;
filtering the data in the connector files; and
storing the filtered connector files as import tables.

8. The method of claim 7 further comprising:
accessing the import tables;
processing information in the import tables to generate at least one staging table; and
processing information in the at least one staging table to generate a gold record.

9. Apparatus for gathering and organizing data pertaining to an entity comprising:
a system_meta schema for controlling data base processing;
a system_DW_1 schema for accessing a first set of asset data;
a system_DW_2 schema for accessing a second set of asset data;
where the system_meta schema switches between system_DW_1 schema and system_DW_2 schema.
